(19) United States
(12) Patent Application Publication
(10) Pub. No.: US 2024/0249644 A1
(43) Pub. Date: Jul. 25, 2024

(54) PATIENT SIMULATOR WITH INTERCHANGEABLE ELECTRICAL CONNECTION SYSTEM FOR EKG, DEFIBRILLATION, AND OTHER MEDICAL TRAINING PROCEDURES

(71) Applicant: GAUMARD SCIENTIFIC COMPANY, INC., Miami, FL (US)

(72) Inventors: Alfredo HERNANDEZ, Miami, FL (US); Alejandro CABALLE, Miami, FL (US)

(21) Appl. No.: 18/416,689

(22) Filed: Jan. 18, 2024

Related U.S. Application Data
(60) Provisional application No. 63/594,751, filed on Oct. 31, 2023.
(60) Provisional application No. 63/480,842, filed on Jan. 20, 2023.

(51) Int. Cl. G09B 23/30

(52) U.S. Cl. CPC G09B 23/30

(57) ABSTRACT

The present disclosure provides interactive education systems, apparatus, components, and methods for teaching patient care that allow for easy and efficient connection to electrical systems, including EKG systems and/or defibrillators, having different connector types. In some aspects, a patient simulator may include a simulated body portion and an electrical connector system. The electrical connector system may include a base fixedly secured to a portion of the simulated body portion. The base may be in electrical communication with EKG and/or defibrillation circuitry of the patient simulator. The electrical connector system may include first and second electrical interface components each configured to be removably coupled to the base and configured to interface with at least one of an EKG connector or a defibrillator connector. The first and second electrical interface components may be structurally different such that each is configured to interface with a different type of EKG and/or defibrillator connector.

### CROSS-REFERENCE TO RELATED APPLICATION(S)

This application claims the benefit of the filing date, and priority to, U.S. application Ser. No. 63/480,842, filed Jan. 20, 2023, the entire disclosure of which is hereby incorporated herein by reference. This application also claims the benefit of the filing date, and priority to, U.S. application Ser. No. 63/594,751, filed Oct. 31, 2023, the entire disclosure of which is hereby incorporated herein by reference.

### INTRODUCTION

The present disclosure relates generally to patient simulators. While it is desirable to train medical personnel in patient care protocols before allowing contact with real patients, textbooks and flash cards lack the important benefits to students that can be attained from hands-on practice. On the other hand, allowing inexperienced students to perform medical procedures on actual patients that would allow for the hands-on practice cannot be considered a viable alternative because of the inherent risk to the patient. Because of these factors patient care education has often been taught using medical instruments to perform patient care activity on a simulator, such as a manikin. Examples of such simulators include those disclosed in U.S. patent application Ser. No. 11/952,559 (Publication No. 20080138778), U.S. patent application Ser. No. 11/952,606 (Publication No. 20080131855), U.S. patent application Ser. No. 11/952,636 (Publication No. 20080138779), U.S. patent application Ser. No. 11/952,669 (Publication No. 20090148822), U.S. patent application Ser. No. 11/952,698 (Publication No. 20080138780), U.S. Pat. No. 7,114,954, U.S. Pat. No. 6,758,676, U.S. Pat. No. 6,503,087, U.S. Pat. No. 6,527,558, U.S. Pat. No. 6,443,735, U.S. Pat. No. 6,193,519, and U.S. Pat. No. 5,853,292, each herein incorporated by reference in its entirety.

While these simulators have been adequate in many respects, they have not been adequate in all respects. Therefore, what is needed is an interactive education system for use in conducting patient care training sessions that is even more realistic and/or includes additional simulated features.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure provides interactive education systems, apparatus, components, and methods for teaching patient care. In some aspects of the present disclosure, a system for teaching patient care is provided. The system may include a patient simulator. In some instances, the patient simulator includes a simulated body portion and an electrical connector system. The simulated body portion may include a torso, extremities (e.g., arms (or portions thereof), hands, legs (or portions thereof), feet), a neck, and/or a head, up to and including a full body manikin. The simulated body portion may vary in size, representing different stages of human development and/or age.

In some aspects, the electrical connector system includes a base fixedly secured to a portion of the simulated body portion. The base may further include a magnetic component. In some instances, the magnetic component is annular. In some instances, the base may be in electrical communication with EKG circuitry of the patient simulator. In some instances, the base may be in electrical communication with defibrillation circuitry of the patient simulator. In some aspects, the base may be fixedly secured to a skin layer of the simulated body portion. The base may have a non-conducting element that separates the magnetic component from the electrical pathway between at least one of an EKG connector or a defibrillator connector and at least one of EKG circuitry or defibrillation circuitry of the patient simulator.

In some aspects, the electrical connector system includes a first electrical interface component configured to be removably coupled to the base. The first electrical interface component may be removably coupled to the base based, at least in part, on an interaction with the magnetic component of the base. In some instances, the first electrical interface component is configured to interface with at least one of an EKG connector (e.g., associated with an EKG monitor) or a defibrillator connector (e.g., associated with an external defibrillator). The first electrical interface component and base may provide an electrical pathway between the at least one of the EKG connector or the defibrillator connector and at least one of EKG circuitry or defibrillation circuitry of the simulated body portion. In some instances, the first electrical interface component is further configured to be removably coupled to the base by a physical connection. The physical connection may also provide an electrical connection. In some instances, a portion of the first electrical interface component extends through a central opening of the magnetic component when the first electrical interface is removably coupled to the base.

In some aspects, the electrical connector system includes a second electrical interface component configured to be removably coupled to the base. The second electrical interface component may be removably coupled to the base based, at least in part, on an interaction with the magnetic component of the base. The second electrical interface component is structurally different than the first electrical interface component. In some instances, the second electrical interface component is configured to interface with at least one of an EKG patch (e.g. associated with an EKG monitor) or a defibrillator patch (e.g. associated with an external defibrillator). In some aspects, the second electrical interface component includes a planar surface. The second electrical interface component and the base may be configured to provide an electrical pathway between the at least one of the EKG patch or the defibrillator patch and at least one of EKG circuitry or defibrillator circuitry of the simulated body portion. The second electrical interface component may be further configured to be removably coupled to the base by a physical connection. In some instances, the physical connection also provides an electrical connection to the base. A portion of the second electrical interface component may extend through a central opening of the magnetic component when the second electrical interface is removably coupled to the base.

In some aspects, a patient simulator includes a plurality of bases, a plurality of first electrical interface components, and a plurality of second electrical interface components. The plurality of the bases may be fixedly secured to the simulated body portion in one or more positions associated with 1-lead, 3-lead, 4 lead, 6-lead, or 12-lead EKG monitoring and/or defibrillation. In some instances, the patient simulator includes at least one of EKG circuitry or defibrillation circuitry.

In some aspects of the present disclosure, an electrical connector system for a simulated body portion is provided. The electrical connector system may include a base. In some instances, the electrical connector system may include a first electrical interface component. In some instances, the electrical connector system may include a second electrical interface component.

In some aspects, the electrical connector system includes a base configured to be fixedly secured to a portion of the simulated body portion. The base may further include a magnetic component. The magnetic component may be annular. In some instances, the base may be in electrical communication with EKG circuitry of the patient simulator. In some instances, the base may be in electrical communication with defibrillation circuitry of the patient simulator. In some aspects, the base is fixedly secured to a skin layer of the simulated body portion. The base may have a non-conducting element that separates the magnetic component from the electrical pathway between at least one of an EKG connector or a defibrillator connector and at least one of EKG circuitry or defibrillation circuitry of the patient simulator.

In some aspects, the electrical connector system includes a first electrical interface component configured to be removably coupled to the base. The first electrical interface component may be removably coupled to the base based, at least in part, on an interaction with the magnetic component of the base. In some instances, the first electrical interface component is configured to interface with at least one of an EKG connector (e.g. associated with an EKG monitor) or a defibrillator connector (e.g. associated with an external defibrillator). The first electrical interface component and base provide an electrical pathway between the at least one of the EKG connector or the defibrillator connector and at least one of EKG circuitry or defibrillation circuitry of the simulated body portion. In some instances, the first electrical interface component is further configured to be removably coupled to the base by a physical connection. The physical connection may also provide an electrical connection. In some instances, a portion of the first electrical interface component extends through a central opening of the magnetic component when the first electrical interface is removably coupled to the base.

In some aspects, an electrical connector system includes a second electrical interface component configured to be removably coupled to the base. The second electrical interface component may be removably coupled to the base based, at least in part, on an interaction with the magnetic component of the base. The second electrical interface component is structurally different than the first electrical interface component. In some instances, the second electrical interface component is configured to interface with at least one of an EKG patch (e.g. associated with an EKG monitor) or a defibrillator patch (e.g. associated with an external defibrillator). In some aspects, the second electrical interface component includes a planar surface. The second electrical interface component and the base may be configured to provide an electrical pathway between the at least one of the EKG patch or the defibrillator patch and at least one of EKG circuitry or defibrillator circuitry of the simulated body portion. The second electrical interface component may be further configured to be removably coupled to the base by a physical connection. In some instances, the physical connection also provides an electrical connection to the base. A portion of the second electrical interface component may extend through a central opening of the magnetic component when the second electrical interface is removably coupled to the base.

In some aspects, an electrical connector system includes a plurality of bases, a plurality of first electrical interface components, and a plurality of second electrical interface components. The plurality of the bases may be fixedly secured to the simulated body portion in one or more positions associated with 1-lead, 3-lead, 4-lead, 6-lead, or 12-lead EKG monitoring and/or defibrillation. In some instances, the patient simulator includes at least one of EKG circuitry or defibrillation circuitry.

In some aspects of the present disclosure, a method for reconfiguring a patient simulator is provided. The method may include obtaining a patient simulator. In some instances, the patient simulator includes a simulated body portion and an electrical connector system. In some instances, the electrical connector system may include a base fixedly secured to a portion of the simulated body portion. In some instances, a first electrical interface component may be removably coupled to the base. In some instances, the first electrical interface component is removably coupled based, at least in part, on a magnetic interaction. In some instances, the base may include a magnetic component. In some instances, the base may be in electrical communication with EKG circuitry of the patient simulator. In some instances, the base may be in electrical communication with defibrillation circuitry of the patient simulator.

In some aspects, the method includes removing the first electrical interface component from the base and coupling a second electrical interface component to the base. The second electrical interface component may be removably coupled to base based, at least in part, on an interaction with the magnetic component of the base. In some instances, the second electrical interface component is structurally different than the first electrical interface component.

In some aspects, the method may include performing an EKG simulation using the simulated body potion, the base, and at least one of the first electrical interface components or the second electrical interface component. In some instances, performing the EKG simulation includes coupling an EKG connector (e.g., associated with an EKG monitor) to the at least one of the first electrical interface component or the second electrical interface component.

In some aspects, the method may include performing a defibrillation simulation using the simulated body portion, the base, and at least one of the first electrical interface component or the second electrical interface component. In some instances, performing the defibrillation simulation includes coupling a defibrillator connector (e.g., associated with an external defibrillator) to the at least one of the first electrical interface component or the second electrical interface component.

In some aspects of the method, removing the first electrical interface component comprises separating a physical connection between the base and the first electrical interface component. Separating the physical connection may also separate an electrical connection between the base and the first electrical interface component. In some aspects, separating the physical connection may include removing a portion of the first electrical interface component through a central opening of the magnetic component of the base.

In some aspects of the present disclosure, the method may include removing a plurality of first electrical interface components from a plurality of bases and coupling a plurality of second electrical interface components to the plurality of bases. In some aspects, the method may include coupling the plurality of second electrical interface components to the simulated body portion in one or more positions associated with 1-lead, 3-lead, 4-lead, 6-lead, or 12-lead

EKG monitoring or defibrillation. The simulated body portion may include a torso, extremities (e.g., arms (or portions thereof), hands, legs (or portions thereof), feet), a neck, and/or a head, up to and including a full body manikin. The simulated body portion may vary in size, representing different stages of human development and/or age.

In some instances, the first electrical interface component is configured to interface with at least one of an EKG connector (e.g., associated with EKG monitor) or a defibrillator connector (e.g., associated with an external defibrillator) and the second electrical interface component is configured to interface with at least one of an EKG patch (e.g., associated with an EKG monitor) or a defibrillator patch (e.g., associated with an external defibrillator). In some instances, the first electrical interface component is configured to interface with at least one of an EKG patch or a defibrillator patch and the second electrical interface component is configured to interface with at least one of an EKG connector or a defibrillator connector.

By way of non-limiting example, an EKG monitor may refer to any of a number of commercially or non-commercially available monitors that record and/or display electrical signals of the heart. By way of non-limiting example, an external defibrillator may refer to any of a number of commercially or non-commercially available defibrillator systems that apply an electrical pulse of various durations and strengths to the human body.

Other aspects, features, and embodiments of the present invention will become apparent to those of ordinary skill in the art, upon reviewing the following description of specific, exemplary instances of the present invention in conjunction with the accompanying figures. While features of the present invention may be discussed relative to certain examples and figures below, all aspects of the present invention can include one or more of the advantageous features discussed herein. In other words, while one or more arrangements may be discussed as having certain advantageous features, one or more of such features may also be used in accordance with the various aspects and examples of the invention discussed herein. In similar fashion, while exemplary aspects may be discussed below in the context of a device, a system, or a method, it should be understood that such exemplary aspects can be implemented in various devices, systems, and methods.

### BRIEF DESCRIPTION OF THE DRAWINGS

Other features and advantages of the present disclosure will become apparent in the following detailed description of illustrative embodiments with reference to the accompanying of drawings, of which:

FIG. 1 is a perspective view of a patient simulator, according to one or more aspects of the present disclosure.

FIG. 2 is a partial cross-sectional side view of a portion of the patient simulator of FIG. 1 showing use of interchangeable electrical interface components, according to one or more aspects of the present disclosure.

FIG. 3 is a perspective view of an electrical interface component coupled to a base, according to one or more aspects of the present disclosure.

FIG. 4 is a perspective view of an electrical interface component coupled to a base, according to one or more aspects of the present disclosure.

FIG. 5 is a perspective view of an electrical interface component coupled to a base, according to one or more aspects of the present disclosure.

FIG. 6 is a perspective view of an electrical interface without harness coupled to a defibrillator base, according to one or more aspects of the present disclosure.

FIG. 7 is a perspective view of an EKG base, according to one or more aspects of the present disclosure.

FIG. 8 is an exploded view of the base of FIG. 7, according to one or more aspects of the present disclosure.

FIG. 9 is a perspective view of an electrical interface component, according to one or more aspects of the present disclosure.

FIG. 10 is an exploded view of the electrical interface component of FIG. 9, according to one or more aspects of the present disclosure.

FIG. 11 is a perspective view of an electrical interface component, according to one or more aspects of the present disclosure.

FIG. 12 is an exploded view of the electrical interface component of FIG. 11, according to one or more aspects of the present disclosure.

FIG. 13 is a perspective of a defibrillation base, according to one or more aspects of the present disclosure.

FIG. 14 is an exploded view of the defibrillation base of FIG. 13, according to one or more aspects of the present disclosure.

FIG. 15 is a perspective view of an electrical interface component without harness, according to one or more aspects of the present disclosure.

FIG. 16 is an exploded view of the electrical interface component of FIG. 15, according to one or more aspects of the present disclosure.

FIG. 17 is a perspective view of an electrical interface component with harness, according to one or more aspects of the present disclosure.

FIG. 18 is a partial cross-sectional side view of a portion of the patient simulator of

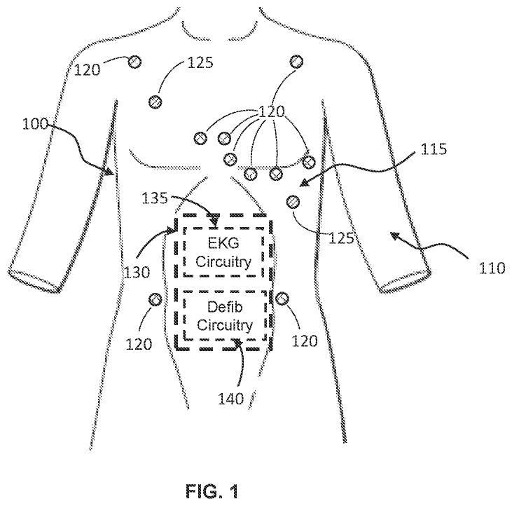

FIG. 1 showing use of interchangeable electrical interface components, according to one or more aspects of the present disclosure.

FIG. 19 is a partial cross-sectional side view of a portion of the patient simulator of FIG. 1 showing use of interchangeable electrical interface components, according to one or more aspects of the present disclosure.

FIG. 20 is a perspective view of an EKG base, according to one or more aspects of the present disclosure.

FIG. 21 is an exploded view of the base of FIG. 20, according to one or more aspects of the present disclosure

FIG. 22 is a perspective view of an electrical interface component, according to one or more aspects of the present disclosure.

FIG. 23 is an exploded view of the electrical interface component of FIG. 22, according to one or more aspects of the present disclosure.

FIG. 24 is a perspective view of an electrical interface component, according to one or more aspects of the present disclosure.

FIG. 25 is an exploded view of the electrical interface component of FIG. 24, according to one or more aspects of the present disclosure.

FIG. 26 is a perspective view of an electrical interface component, according to one or more aspects of the present disclosure.

FIG. 27 is an exploded view of the electrical interface component of FIG. 26, according to one or more aspects of the present disclosure.

FIG. 28 is a perspective view of an electrical interface component, according to one or more aspects of the present disclosure.

FIG. 29 is an exploded view of the electrical interface component of FIG. 28, according to one or more aspects of the present disclosure.

FIG. 30 is a perspective view of an electrical interface component, according to one or more aspects of the present disclosure.

FIG. 31 is a cross-sectional view of the electrical interface component of FIG. 30, according to one or more aspects of the present disclosure.

FIG. 32 is a perspective of a defibrillation base, according to one or more aspects of the present disclosure.

FIG. 33 is an exploded view of the defibrillation base of FIG. 32, according to one or more aspects of the present disclosure.

FIG. 34 is a perspective view of defibrillator connectors, according to aspects of the present disclosure.

FIG. 35 is a partially exploded view of the defibrillator connectors of FIG. 34, according to aspects of the present disclosure.

FIG. 36 is a perspective view of an electrical interface component removal tool, according to aspects of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications in the described devices, instruments, methods, and any further application of the principles of the disclosure as described herein are contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately. For simplicity, in some instances the same reference numbers are used throughout the drawings to refer to the same or like parts. One of ordinary skill in the art will appreciate that two or more components may be affixed to one another via epoxy or other adhesive means, even if not explicitly stated.

Generally, the present disclosure describes systems and methods for using patient simulators capable of interfacing with medical equipment, such as one or more types of medical treatment and/or diagnostic equipment. The components of the patient simulator that interface with the medical equipment may be interchangeable to allow use of the appropriate interface for connection with the particular type of medical equipment being used. Multiple types of connectors are used in EKG monitoring that allow transmission of physical signals from the body to the monitoring equipment. Similarly, multiple types of connectors are used in defibrillation equipment to facilitate transmission electrical pulses of various strength and durations to the human body. Hospitals and other facilities for medical training may have a variety of different equipment that utilize different types of connectors. Accordingly, a simulator that only works with one type of connector will be inadequate to train across the variety of medical equipment. The descriptions that follow provide the solution.

Referring to FIG. 1, shown therein is a perspective view of a patient simulator 100 according to one or more aspects of the present disclosure. The patient simulator 100 may include a simulated body portion 110. In some instances, the simulated body portion 110 may include a torso, extremities (e.g., arms (or portions thereof), hands, legs (or portions thereof), feet), a neck, and/or a head, up to and including a full body manikin. In some instances, the simulated body portion 110 may vary in size, representing different stages of human development and/or age.

The patient simulator 100 may include an electrical connector system 115. The electrical connector system 115 may include a plurality of electrical connectors (e.g., electrocardiogram (hereinafter, “EKG” or “ECG”) connectors 120 and defibrillation connectors 125) coupled to the patient simulator 100. Each of the plurality of electrical connectors (EKG connectors 120 and/or defibrillation connectors 125) may include a base fixedly secured to a portion of the simulated body portion, a first electrical interface component configured to be removably coupled to the base based, at least in part, on an interaction with a magnetic component of the base; and a second electrical interface component configured to be removably coupled to the base based, at least in part, on an interaction with the magnetic component. The second electrical interface component may be structurally different than the first electrical interface component. In FIG. 1, the electrical connector system 115 includes a plurality of EKG connectors 120 and a plurality of defibrillation connectors 125.

The electrical connector system 115 may be in electrical communication with one or more electrical control modules 130 of the patient simulator 100. In FIG. 1, the simulated body portion 110 is shown having EKG circuitry 135 and defibrillation circuitry 140. In some aspects, the EKG circuitry 135 and the defibrillation circuitry 140 may be separate components within the simulated body portion 110. In some aspects, the EKG circuitry 135 and the defibrillation circuitry 140 may be a common component within the simulated body portion 110. In some aspects, the EKG circuitry 135 and the defibrillation circuitry 140 may share one or more components within the simulated body portion 110. The EKG circuitry 135 may be configured to simulate selected rhythms from a built-in library associated with the patient simulator 100 and/or rhythms designed by a user using a wave editor. In some instances, the EKG circuitry 135 may be in electrical communication with EKG connectors 120 (e.g., via one or more wires, interfaces, or other electrical connections). The EKG connectors 120 may have the same or different configuration (e.g., multiple structural configurations among the EKG connectors 120). The defibrillation circuitry 140 may be configured to receive live energy from real defibrillators (e.g., Philips HeartStart defibrillators, HeartSine Samaritan defibrillators, Zoll defibrillators, Defibtech Lifeline defibrillators, etc.). In some instances, the defibrillation circuitry 140 may be configured to support double sequential external defibrillation. The defibrillation circuitry 140 may also model the response of the human heart to simulate the response of the patient simulator 100 to the defibrillation treatment. The defibrillation circuitry 140 may be in electrical communication with defibrillation connectors 125 (e.g., via one or more wires, interfaces, or other electrical connections). The defibrillation connectors 125 may have the same or different configuration (e.g., multiple structural configurations among the defibrillations connectors 125).

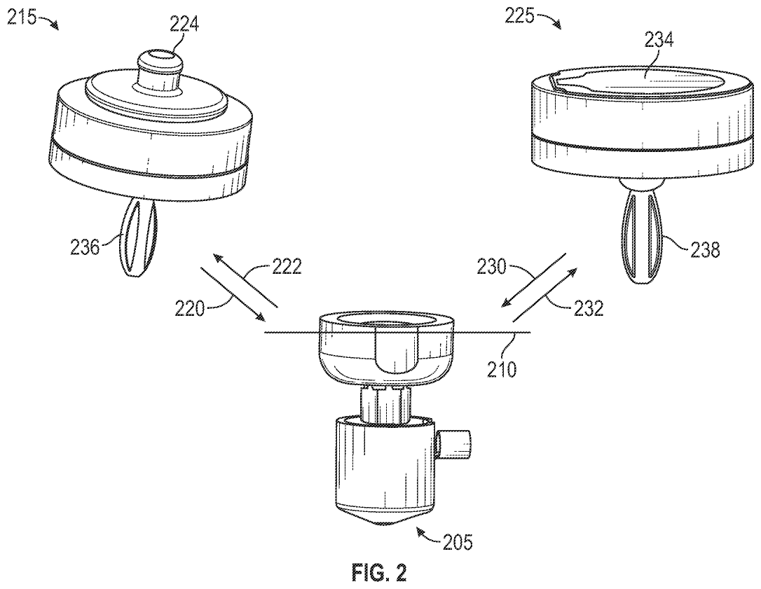

Referring to FIG. 2, shown therein is a partial cross-sectional side view of a portion of the patient simulator 100 of FIG. 1 showing use of interchangeable electrical interface components, according to one or more aspects of the present disclosure. Each of the plurality of electrical connectors of the electrical connector system 115 may include a base 205. The base 205 may be fixedly attached to the simulated body portion 110. In some instances, the base 205 may be fixedly attached to and/or within a skin layer 210 of the simulated body portion 110. In some instances, the base 205 may be configured to be in electrical communication with the EKG circuitry 135 and/or defibrillation circuitry 140. The base 205 may include a magnetic component. The magnetic component may have any suitable shape, including annular, geometrical, non-geometrical, and/or combinations thereof. The magnetic component may include a single piece or multiple pieces. In some instances, the base 205 may be fixed to the simulated body portion using any suitable technique, including through the use of one or more fasteners, adhesives, welds, and/or other mechanisms for fixedly connecting the base 205 to a portion of the simulated body portion of the patient simulator. In some aspects, an outer surface of the base 205 may be recessed relative to a skin surface of the patient simulator 100, generally aligned with the skin surface of the patient simulator 100, or raised above the skin surface of the patient simulator 100.

A first electrical interface component 215 may be removably coupled 220 and/or uncoupled 222 from the base 205. When removably coupled 220 to the base 205, the coupling or attachment to the base 205 may be based at least in part on an interaction with a magnetic component in the base. By way of non-limiting example, the first electrical interface component 215 may be configured with a snap connection interface 224 as depicted in FIG. 2.

A second electrical interface component 225 that may be removably coupled 230 or uncoupled 232 from the base 205, and when coupled to the base 205, the second electrical interface component 215 is removably coupled or attached. The coupling or attaching may be based at least in part on an interaction with a magnetic component in the base. By way of non-limiting example, the second electrical interface component 225 may be configured with a planar connection interface 234. Thus, by way of the non-limiting example depicted in FIG. 2, the first electrical interface component 215 and the second electrical interface component 225 may be structurally different, based at least in part on their different connector configurations. If there is no electrical interface component coupled to the base 205, then either the first electrical interface component 215 may be removably coupled 220 or the second electrical interface component 225 may be removably coupled 232 to the base 205.

In some instances, the first electrical interface component 215 and/or the second electrical interface component 225 include a banana plug connector 236, 238 where the male component is integrated into the electrical interface component 215, 225 and the female component of the connector is integrated into the base 205, as shown in FIG. 2. In some instances, the banana plug connector 236, 238 extends through and engages a central opening of base 205. In some aspects, the central opening may be an opening in the magnetic component (e.g., an annular magnetic component) of the base 205. In some instances, the first electrical interface component 215 and/or the second electrical interface component 225 may include a banana plug connector where the male component is integrated into the base 205 and the female component of the connector is integrated into the electrical interface component 215, 225.

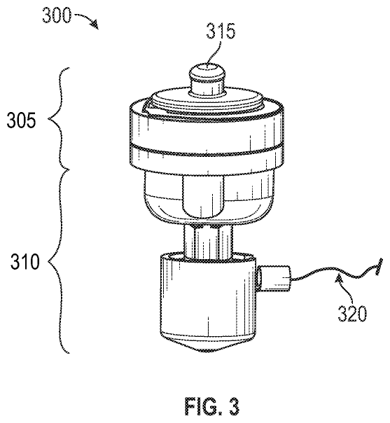

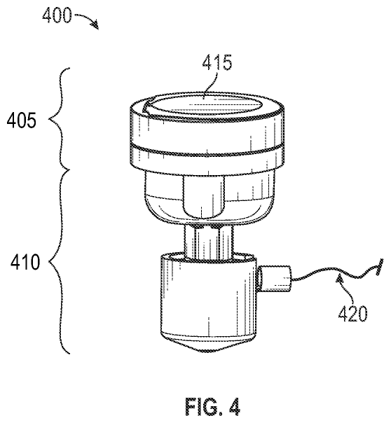

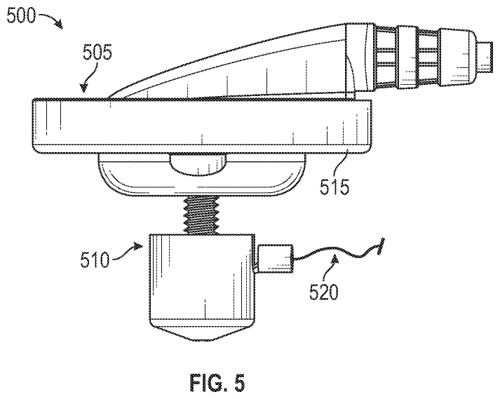

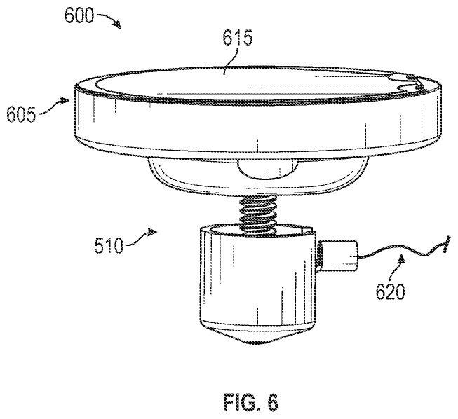

Referring now to FIGS. 3-6, shown therein are multiple configurations of EKG and/or defibrillations connectors, according to one or more aspects of the present disclosure. In this regard, FIG. 3 is a perspective view of a first electrical interface component coupled to a first base. FIG. 4 is a perspective view of a second electric interface component coupled to a first base. FIG. 5 is a perspective view of a third electrical interface component coupled to a second base. FIG. 6 is a perspective view of a fourth electrical interface component coupled to a second base.

Referring to FIG. 3, shown therein is a perspective view of an electrical interface component coupled to a base, according to one or more aspects of the present disclosure. In some instances, an EKG connector 120 of FIG. 1 maybe configured as a first EKG connector 300. A first EKG connector 300 may include a first electrical interface component 305 removably coupled to an EKG base 310, as depicted in FIG. 3. In some instances, the first electrical interface component 305 may have a first structural configuration for EKG. In some instances, the EKG base 310 is configured to removably couple to electrical interface components configured for EKG.

The electrical interface component 305 may be removably coupled to the base 310 based at least in part on a magnetic interaction. In some instances, the first electrical interface component 305 may include a physical connection, e.g., banana plug. In some instances, the male component of the banana plug connector is integrated into the electrical interface component 305 and the female component of the connector is integrated into the base 310. The EKG base 310 includes a magnetic component. The magnetic component may have any suitable shape, including annular, geometrical, non-geometrical, and/or combinations thereof. The magnetic component may include a single piece or multiple pieces. In some instances, the electrical interface component 305 extends through a central opening of the magnetic component (e.g., an annular magnetic component) when the electrical interface component 305 is removably coupled to the base 310. When removably coupled to the base 310, the electrical interface component 305 and the base 310 may be in electrical communication.

The base 310 may be fixedly attached to the simulated body portion 110. In some instances, the base 310 may be fixed to the simulated body portion using any suitable technique, including through the use of one or more fasteners, adhesives, welds, and/or other mechanisms for fixedly connecting the base 310 to a portion of the simulated body portion 110 of the patient simulator 100. The base 310 may be configured to be in electrical communication with the EKG circuitry 135, depicted in FIG. 1. The EKG circuitry may be disposed within the patient simulator 100. In some stances, electrical communication is accomplished by means of an electrical conduit, e.g., a wire, 320.

In some configurations the electrical interface component has a snap connection interface 315, which is capable of coupling to EKG training equipment. In some instances, the snap connection interface 315 is integrally connected to the first electrical interface component 305. In some instances, the snap connection interface 315 is formed as a single structure with other components of the first electrical interface component 305. In some instances, the snap connection interface 315 is a fixedly attached to one or more separate components that together comprise the first electrical interface component 305. When the EKG training equipment is removably coupled to the EKG connector 300 via the mating of the snap connection interface 315 and its complementary interface on the EKG training equipment, the EKG connector 300 and the EKG training equipment may be in electrical communication.

When the EKG connector 300 is in electrical communication, e.g., via the electrical conduit 320, and removably coupled, via the electrical interface component 305, to the EKG training equipment, the EKG training equipment and the EKG circuitry may be in electrical communication. In some instances, a plurality of EKG connectors 300 may be configured to place the EKG training equipment and the EKG circuitry in electrical communication simultaneously.

Referring to FIG. 4, shown therein is a perspective view of an electrical interface component coupled to a base, according to one or more aspects of the present disclosure. In some instances, an EKG connector 120 of FIG. 1 maybe configured as a second EKG connector 400. A second EKG connector 400 may include a second electrical interface component 405 removably coupled to an EKG base 410, as depicted in FIG. 4. In some instances, the second electrical interface component 405 may have a second structural configuration for EKG. The first electrical interface component 305 and the second electrical interface component 405 may be structurally distinct. In some instances, the EKG base 410 is configured to removably couple to electrical interface components configured for EKG.

The electrical interface component 405 may be removably coupled to the EKG base 410 based at least in part on a magnetic interaction. In some instances, the second electrical interface component 405 may include a physical connection, e.g., a banana plug. In some instances, the male component of the banana plug connector is integrated into the second electrical interface component 405 and the female component of the connector is integrated into the EKG base 410. The EKG base 410 includes a magnetic component. The magnetic component may have any suitable shape, including annular, geometrical, non-geometrical, and/or combinations thereof. The magnetic component may include a single piece or multiple pieces. In some instances, the second electrical interface component 405 extends through a central opening of the magnetic component (e.g., an annular magnetic component) when the second electrical interface component 405 is removably coupled to the EKG base 410. When removably coupled to the EKG base 410, the second electrical interface component 405 and the EKG base 410 may be in electrical communication.

The EKG base 410 may be fixedly attached to the simulated body portion 110. In some instances, the EKG base 410 may be fixedly attached to the simulated body portion 110 using any suitable technique, including through the use of one or more fasteners, adhesives, welds, and/or other mechanisms for fixedly connecting the EKG base 410 to a portion of the simulated body portion 110 of the patient simulator 100. The EKG base 410 may be configured to be in electrical communication with the EKG circuitry 135, depicted in FIG. 1. The EKG circuitry 135 may be disposed within the patient simulator 100. In some stances, electrical communication is accomplished by means of an electrical conduit 420, e.g., a wire.

In some configurations the electrical interface component has a planar connection interface 415, which is capable of coupling to EKG training equipment. In some instances, the planar connection interface 415 is integrally connected to the first electrical interface component 405. In some instances, the planar connection interface 415 is formed as a single structure with other components of the first electrical interface component 405. In some instances, the planar connection interface 415 is a fixedly attached to one or more separate components that together comprise the second electrical interface component 405. When the EKG training equipment is removably coupled to the EKG connector 400 via the mating of the planar connection interface 415 and its complementary interface on the EKG training equipment, the second EKG connector 400 and the EKG training equipment may be in electrical communication.

When the second EKG connector 400 is in electrical communication, e.g., via the electrical conduit 420, and removably coupled, via the second electrical interface component 405, to the EKG training equipment, the EKG training equipment and the EKG circuitry may be in electrical communication. In some instances, a plurality of second EKG connectors 400 may be configured to place the EKG training equipment and the EKG circuitry in electrical communication simultaneously.

Referring to FIG. 5, shown therein is a perspective view of an electrical interface component coupled to a base, according to one or more aspects of the present disclosure. In some instances, a defibrillation connector 125 of FIG. 1 maybe configured as a first defibrillation connector 500. The first defibrillation connector 500 may include a first defibrillation electrical interface component 505 removably coupled to a defibrillation base 510, as depicted in FIG. 5. In some instances, the first defibrillation electrical interface component 505 may have a first structural configuration for defibrillation. In some instances, the second base 510 is configured to removably couple to electrical interface components configured for defibrillation.

The first defibrillation electrical interface component 505 may be removably coupled to the second base 510 based at least in part on a magnetic interaction. The second base 510 includes a magnetic component. The magnetic component may have any suitable shape, including annular, geometrical, non-geometrical, and/or combinations thereof. The magnetic component may include a single piece or multiple pieces. In some instances, the first defibrillation electrical interface component 505 closes a central opening of the magnetic component (e.g., an annular magnetic component) when the first defibrillation electrical interface component 505 is removably coupled to the second base 510. When removably coupled to the second base 510, the first defibrillation electrical interface component 505 and the second base 510 may be in electrical communication.

The second base 510 may be fixedly attached to the simulated body portion 110. In some instances, the second base 510 may be fixedly attached to the simulated body portion 110 using any suitable technique, including through the use of one or more fasteners, adhesives, welds, and/or other mechanisms for fixedly connecting the second base 510 to a portion of the simulated body portion 110 of the patient simulator 100. The second base 510 may be configured to be in electrical communication with the defibrillation circuitry 140, as depicted in FIG. 1. In some stances, electrical communication comprised by an electrical conduit 520, e.g., a wire.

In some configurations the first defibrillation electrical interface component 505 is a portion of the defibrillation training equipment. In some instances, the planar connection interface 515 is integrally connected to the first defibrillation electrical interface component 505.

In some instances, the planar connection interface 515 is formed as a single structure with other components of the first electrical interface component 505. In some instances, the planar connection interface 515 is fixedly attached to one or more separate components that together comprise the first defibrillation electrical interface component 505. In some instances, when the defibrillation training equipment is removably coupled to the first defibrillation connector 500 via the mating of the planar connection interface 515 and its complementary interface on the second base, the first defibrillation connector 500 and the defibrillation training equipment may be in electrical communication. In some instances, when the defibrillation training equipment is removably coupled to the first defibrillation connector receiver via the coupling of the planar connection interface 515 to the second base 510.

When the first defibrillation connector 500 is in electrical communication, e.g., via the electrical conduit 520, and removably coupled, via the first defibrillation electrical interface component 505, to the EKG training equipment, the EKG training equipment and the EKG circuitry may be in electrical communication. In some instances, a plurality of first defibrillation connectors 500 may be configured to place the defibrillation training equipment and the defibrillation circuitry in electrical communication.

Referring to FIG. 6, shown therein is a perspective view of an electrical interface component coupled to a base, according to one or more aspects of the present disclosure. In some instances, a defibrillation connector 125 of FIG. 1 maybe configured as a second defibrillation connector 600. The second defibrillation connector 600 may include a second defibrillation electrical interface component 605 removably coupled to a second base 510, as depicted in FIG. 5. In some instances, the second defibrillation electrical interface component 605 may have a second structural configuration for defibrillation. The first defibrillation connector 500 and the second defibrillation connector 600 may be structurally distinct. In some instances, the second base 510 is configured to removably couple to electrical interface components configured for defibrillation.

The second defibrillation electrical interface component 605 may be removably coupled to the second base 510 based at least in part on a magnetic interaction. The second base 510 includes a magnetic component. The magnetic component may have any suitable shape, including annular, geometrical, non-geometrical, and/or combinations thereof. The magnetic component may include a single piece or multiple pieces. In some instances, the second defibrillation electrical interface component 605 covers a central opening of the magnetic component (e.g., an annular magnetic component) when the second defibrillation electrical interface component 605 is removably coupled to the second base 510. When removably coupled to the second base 510, the second defibrillation electrical interface component 605 and the second base 510 may be in electrical communication.

The second base 510 may be fixedly attached to the simulated body portion 110. In some instances, the second base 510 may be fixedly attached to the simulated body portion 110 using any suitable technique, including through the use of one or more fasteners, adhesives, welds, and/or other mechanisms for fixedly connecting the second base 510 to a portion of the simulated body portion 110 of the patient simulator 100. The second base 510 may be configured to be in electrical communication with the defibrillation circuitry 140, as depicted in FIG. 1. In some stances, electrical communication comprised by an electrical conduit 620, e.g., a wire.

In some instances, the planar connection interface 615 is integrally formed in the second defibrillation electrical interface component 605. In some instances, the planar connection interface 615 is formed as a single structure with other components of the second electrical interface component 605. In some instances, the planar connection interface 615 is fixedly attached to one or more separate components that together comprise the second defibrillation electrical interface component 605. In some instances, when the defibrillation connector of the training equipment is removably coupled to the second defibrillation connector 600, e.g., via the mating of the planar connection interface 615 and its complementary interface in the defibrillation connector of the training equipment, the second defibrillation connector 600 and the defibrillation training equipment may be in electrical communication.

When the second defibrillation connector 600 is in electrical communication, e.g., via the electrical conduit 620, and removably coupled, via the second defibrillation electrical interface component 605, to the defibrillation training equipment, the defibrillation training equipment and the defibrillation circuitry 140 may be in electrical communication. In some instances, a plurality of second defibrillation connectors 600 may be configured to place the defibrillation training equipment and the defibrillation circuitry 140 in electrical communication.

In the description that follows, and elsewhere when otherwise not defined, “proximal” is defined as nearer to the patient simulator and “distal” is defined as further from the patient simulator. For example, if component A is located proximal to component B, then component A is closer to the patient simulator than component B. In addition, reference to “lateral” or “laterally” refer to directions in a plane orthogonal to the proximal-distal direction/axis. The proximal-distal direction defines a longitudinal axis for the discussion of components which follow.

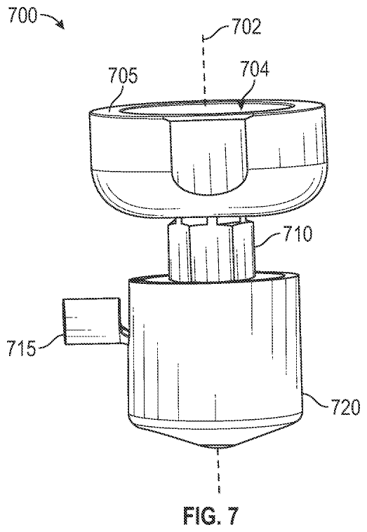

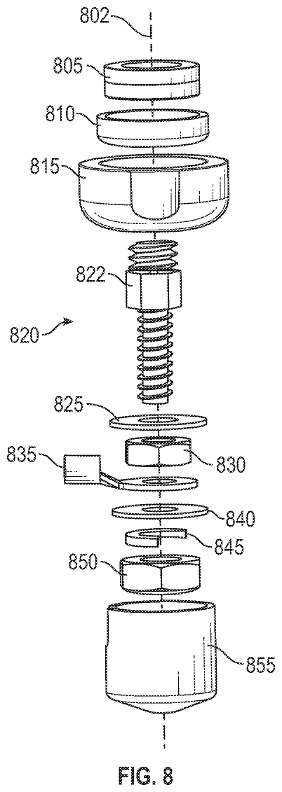

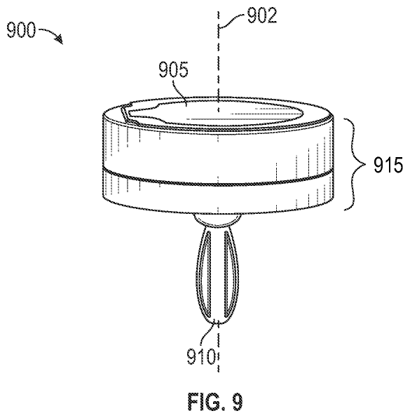

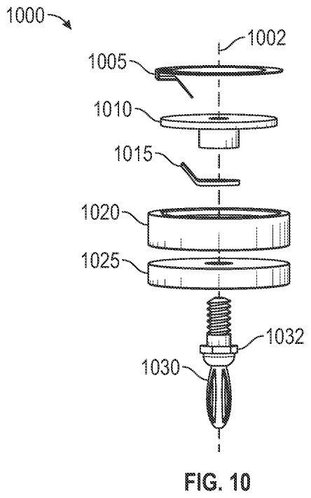

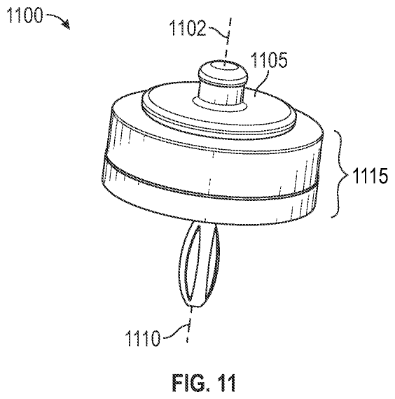

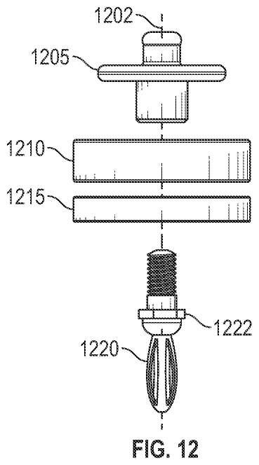

FIGS. 7-12 depict a base and electrical interface components configured for EKG. An exploded view of each of the base and electrical interface components depicts the plurality of constituent elements comprising the base and electrical interface components. In this regard, FIG. 7 is a perspective view of an EKG base. FIG. 8 is an exploded view of the base of FIG. 7. FIG. 9 is a perspective view of a first EKG electrical interface component. FIG. 10 is an exploded view of the first EKG electrical interface component of FIG. 9. FIG. 11 is a perspective view of a second EKG electrical interface component. FIG. 12 is an exploded view of the second EKG electrical interface component of FIG. 11.

Referring to FIG. 7, shown therein is a perspective view of an EKG base 700, according to one or more aspects of the present disclosure. FIG. 7 includes a longitudinal axis 702, aligned with the proximal-distal axis. The EKG base 700 may include a central opening at the distal end, a conductive component 710, a channel 715 for receiving a connection to EKG circuitry 135, and a containing element 720 at the proximal end of the EKG base. When configured the EKG base 700 facilitates electrical communication between the EKG circuitry 135 and external EKG equipment.

In some instances, the central opening 705, located at the distal end of the EKG base 700, allows for portions of electrical interface components to extend through the central opening 705. The central opening 705 may be configured to have a cross section in a plane transverse to the longitudinal axis of the base.

In some aspects, the conductive component 710 facilitates electrical communication between a removably coupled electrical interface component and the EKG circuitry. The conductive component may also serve as a means for physical connection of the base 700 with an electrical interface component. In some instances, the channel 715 may receive or deliver a wire to the components of the base forming the electrical pathway. By way of non-limiting example, the wire may connect to the conductive component 710.

In some instances, the containing element 720 is cylindrical in shape with an end cap at one end of the cylinder, where the axis of the cylinder is parallel to the longitudinal axis of the base. The containing element 720 may facilitate the physical connection to the patient simulator 100. In particular, the outer surface of the containing element may be in physical contact with the simulated body portion 110.

Referring to FIG. 8, shown therein is an exploded view of the EKG base of FIG. 7, according to one or more aspects of the present disclosure. FIG. 8 includes a longitudinal axis 802, aligned with the proximal-distal axis. A magnet 805 is disposed concentrically interior to a stabilizing body 810, where the center of the concentrically disposed components are defined by the longitudinal axis 802. A magnet holder 815 is disposed proximally relative to the magnet 805 and stabilizing body 810. A magnetic jack screw 820 is comprised by a laterally extended portion 822 that may be proximally located relative to the magnet holder 815. A first flat washer 825 is proximally located relative to the laterally extended portion 822 of the magnetic jack screw 820. A first nut 830 is located proximally to the first flat washer 825. A terminal ring 835 is located proximally to the first nut 830. A second flat washer 840 is located proximally to the terminal ring 835. A lock washer 845 is located proximally to the second flat washer 840. A lock nut 850 is located proximally to the lock washer 845. A cap 855 is located proximally to the lock nut 850.

Referring to FIG. 9, shown therein is a perspective view of an electrical interface component configured for EKG, according to one or more aspects of the present disclosure. FIG. 9 includes a longitudinal axis 902, aligned with the proximal-distal axis. The first EKG electrical interface component 900 may include a planar surface 905, banana plug 910, and first EKG interface body 915.

In some instances, the planar surface 905 is comprised of electrically conductive material. The planar surface 905 may be put into electrical contact with an EKG connector associated with EKG training equipment. In some instances, the planar surface 905 comprises a portion of the electrical pathway between the EKG circuitry 135 and the EKG training equipment.

In the some instances the banana plug 910 provides a mechanism for physical connection between the first EKG electrical interface component and the EKG base 700. When engaged with the EKG base 700, the banana plug 910 causes the first EKG electrical interface component 900 to be removably coupled to the EKG base 700. In some instances, when the banana plug 910 is engaged with the EKG base 700, it provides an electrical connection and/or a physical connection. When coupling the first EKG interface component 900 with the EKG base 700, the banana plug 910 extends through the central opening 704 of the EKG base 700.

In some instances, the first EKG interface body 915 comprises a component that interacts with the magnet 805 in the EKG base 700.

Referring to FIG. 10, shown therein is an exploded view of the electrical interface component of FIG. 9, according to one or more aspects of the present disclosure. FIG. 10 includes a longitudinal axis 1002, aligned with the proximal-distal axis. A golden pad 1005 is disposed distally relative to a magnetic pad cap 1010. In some stances the golden pad 1005 may have a portion that folds over the magnetic pad cap 1010 such that the portion is disposed proximally relative to the magnetic pad cap 1010. A terminal ring 1015 is disposed proximally relative to the magnetic pad cap 1010. In some stances, the terminal ring 1015 is configured to be in physical and/or electrical contact with the portion of the golden pad 1005. A pad support 1020 is disposed proximally relative to the terminal ring 1015. In some stances, the pad support 1020 is configured to conformably contain the terminal ring 1015, magnetic pad cap 1010, and golden pad 1005, such that the furthest distal extent of the pad support 1020 and the golden pad are equivalent up to the largest longitudinal thickness of the golden pad 1005. A magnet holder cap 1025 is disposed proximally relative to the pad support 1020. A banana plug 1030 is comprised by a laterally extended portion 1032 that may be proximally located relative to the magnet holder cap 1025.

Referring to FIG. 11, shown therein is a perspective view of an electrical interface component configured for EKG, according to one or more aspects of the present disclosure. FIG. 11 includes a longitudinal axis 1102, aligned with the proximal distal axis. A second EKG electrical interface component 1100 may include a snap connection interface 1105, banana plug 1110, and first EKG interface body 1115.

In some instances, the snap connection interface 1105 is comprised of electrically conductive material. The snap connection interface 1105 maybe put into electrical contact with an EKG connector associated with EKG equipment. In some instances, the snap connection interface comprises a portion of the electrical pathway between the EKG circuitry 135 and the EKG equipment.

In the some instances the banana plug 1110 provides a mechanism for physical connection between the second EKG electrical interface component 1100 and the EKG base 700. When engaged with the EKG base 700 via the banana plug 1110, the second EKG electrical interface component 1100 is removably coupled to the EKG base 700. In some instances, when the banana plug is engaged with the EKG base 700, it provides an electrical connection in addition to a physical connection. When coupling the second EKG electrical interface component 1100 with the EKG base 700, the banana plug 1110 extends through the central opening 704 of the EKB base 700.

In some instances, the second EKG interface body 1115 comprises a component that interacts with the magnetic component of the magnet 805 in the EKG base 700.

Referring to FIG. 12, shown therein is an exploded view of the electrical interface component of FIG. 11, according to one or more aspects of the present disclosure. FIG. 12 includes a longitudinal axis 1202, aligned with the proximal-distal axis. A magnetic snap 1205 is disposed distally relative to a snap support 1210. A magnet holder cap 1215 is disposed proximally relative to the snap support 1210. A banana plug 1220 is comprised by a laterally extended portion 1222 that may be proximally disposed relative to the magnet holder cap 1215.

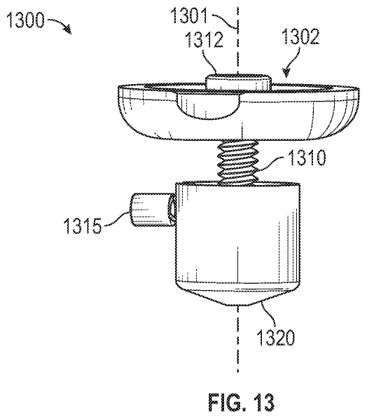

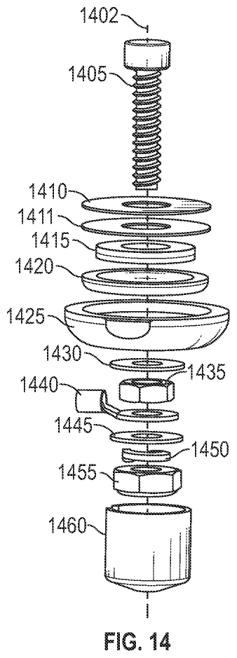

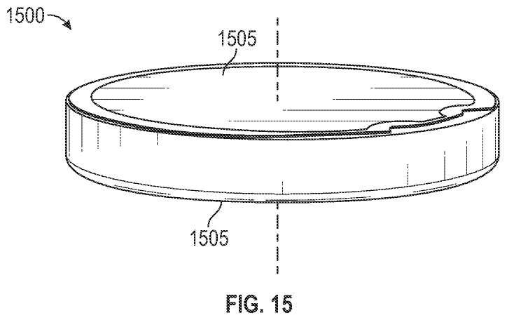

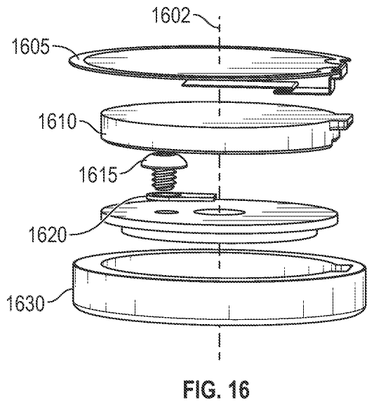

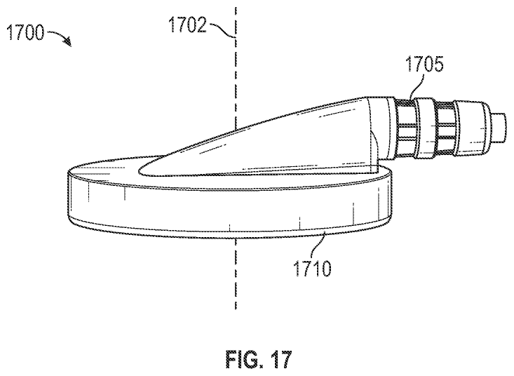

FIGS. 13-17 depict a base and electrical interface components configured for defibrillation. Exploded views of the base and electrical interface components depict the plurality of constituent elements comprising the base and electrical interface components. In this regard, FIG. 13 is a perspective view of a defibrillation base. FIG. 14 is an exploded view of the base of FIG. 13. FIG. 15 is a perspective view of an electrical interface component. FIG. 16 is an exploded view of the electrical interface component of FIG. 15. FIG. 17 is a perspective view of an electrical interface component.

Referring to FIG. 13, shown therein is a perspective view of a defibrillation base 1300, according to one or more aspects of the present disclosure. FIG. 13 includes a longitudinal axis 1301, defining a proximal-distal direction. The defibrillation base 1300 may include a central opening 1302 at the distal end of the defibrillation base 1300, a conductive component 1310, a channel 1315 for receiving a connection to defibrillation circuitry 140, a containing element 1320 at the proximal end of the defibrillation base 1300. In some instances, the defibrillation base 1300 comprises an electrical pathway whereby the defibrillation circuitry 140 and external defibrillation equipment are in electrical communication.

In some instances, the central opening 1302, located at the distal end of the defibrillation base 1300, allows for portions of electrical interface components to extend through the central opening 1302. The central opening 1302 maybe configured to have a cross section in a plane transverse to the longitudinal axis of the base. In some instances, a conductive component 1310 comprises a screw whose head 1312 may extend distally through the central opening 1302.

In some instances, the conductive component 1310 comprises an electrical pathway that allows electrical communication between a removably coupled electrical interface component and the defibrillation circuitry 140. The conductive component 1310 may also serve as a means for physical connection between an electrical interface component, e.g., by receiving a banana plug in the head 1312 of the screw.

In some instances, the channel 1315 may receive or deliver a wire to the components of the base comprising the electrical pathway. By way of non-limiting example, the wire may be in direct or indirect electrical communication with the conductive component 1310.

In some instances, the containing element 1320 is cylindrical in shape with one end of the cylinder closed, where the axis of the cylinder is parallel to the longitudinal axis 1301 of the defibrillation base. The containing element 1320 maybe in physical contact with the simulated body portion 110. In particular, the outer surface of the containing element 1320 maybe in physical contact with the simulated body portion 110.

Referring to FIG. 14, shown therein is an exploded view of the defibrillation base of FIG. 13, according to one or more aspects of the present disclosure. FIG. 14 includes a longitudinal axis 1402, aligned with the proximal-distal axis. A red/black plastic washer 1410/1400 is disposed distally relative to a magnet 1415 and a defibrillation body epoxy resin 1420. A magnet 1415 is disposed concentrically interior to the defibrillation body epoxy resin 1420, where the center of the concentrically disposed components are defined by the longitudinal axis 1402. A defibrillation magnet holder 1425 is disposed proximally relative to the defibrillation body epoxy resin 1420. A first flat washer 1430 is disposed proximally relative to the defibrillation magnet holder 1425. A nut 1435 is disposed proximally relative to the first flat washer 1430. A terminal ring 1440 is disposed proximally relative to the nut 1435. A second flat washer 1445 is disposed proximally relative to the terminal 1440. A lock washer 1450 is disposed proximally relative to the second flat washer 1445. A lock nut 1455 is disposed proximally relative to the lock washer 1450. A cap 1460 is disposed proximally relative to the lock nut 1455. In some instances, the cap has a cylindrical portion which surrounds some components, e.g. the first flat washer 1430, the nut 1435, a portion of the terminal ring 1440, the second flat washer 1445, the lock washer 1450, and the lock nut 1455. A brass screw 1405 passes through every component of FIG. 14. In the order described components with threading, such as the nut and lock nut, are complementarily fastened onto the screw via their respective threading.

Referring to FIG. 15, shown therein is a perspective view of an electrical interface component without harness, according to one or more aspects of the present disclosure. FIG. 15 includes a longitudinal axis 1502, aligned with the proximal-distal axis. The first defibrillation electrical interface component 1500 includes a planar surface 1505 on the distal end of the first defibrillation electrical interface component 1500. In some instances, the planar surface 1505 is comprised of electrically conductive material. The planar surface 1505 maybe put into electrical contact with a defibrillation connector associated with defibrillation equipment. In some instances, the planar surface 1505 comprises an electrical pathway between the defibrillation circuitry 140 and the defibrillation equipment.

In some instances, the proximal end 1505 of the first defibrillation electrical interface component 1500 is in physical contact with the head 1312 when the defibrillation base 1300 and the first defibrillation electrical interface component 1500 are removably coupled. In some instances, removable coupling of the first defibrillation electrical interface component 1500 and the defibrillation base 1300 is achieved by a magnetic interaction between the magnet 1415, contained in the defibrillation base 1300, and first defibrillation electrical interface component 1500.

Referring to FIG. 16, shown therein is an exploded view of the electrical interface component of FIG. 15, according to one or more aspects of the present disclosure. FIG. 16 includes a longitudinal axis 1602, aligned with the proximal-distal axis. A defibrillation golden pad 1605 is disposed distally relative to a defibrillation pad support cap 1610. In some instances, the golden pad 1605 may have a portion that folds over the magnetic pad cap 1610 such that the portion, to some extent, is disposed proximally relative to the magnetic pad cap 1610. A screw 1615 is disposed proximally relative to the magnetic pad cap 1610. a terminal ring 1620 is disposed distally relative to a defibrillation magnet holder cap 1625 and is fastened to the same by the screw 1615. The defibrillation magnet holder cap 1625 is disposed distally relative to a defibrillation pad support 1630. In some instances, the defibrillation pad support is configured to contain some of the elements (e.g., defibrillation pad support cap 1610, screw 1615, terminal ring 1620, and defibrillation magnet holder cap 1625) such that they are not externally visible when assembled.

Referring to FIG. 17, shown therein is a perspective view of an electrical interface component with harness. FIG. 17 includes a longitudinal axis 1702, aligned with the proximal-distal axis. The second defibrillation electrical interface component 1700 includes a harness 1705 and a proximal surface 1710. The harness 1705 may partially surround an electrical conduit to defibrillation training equipment.

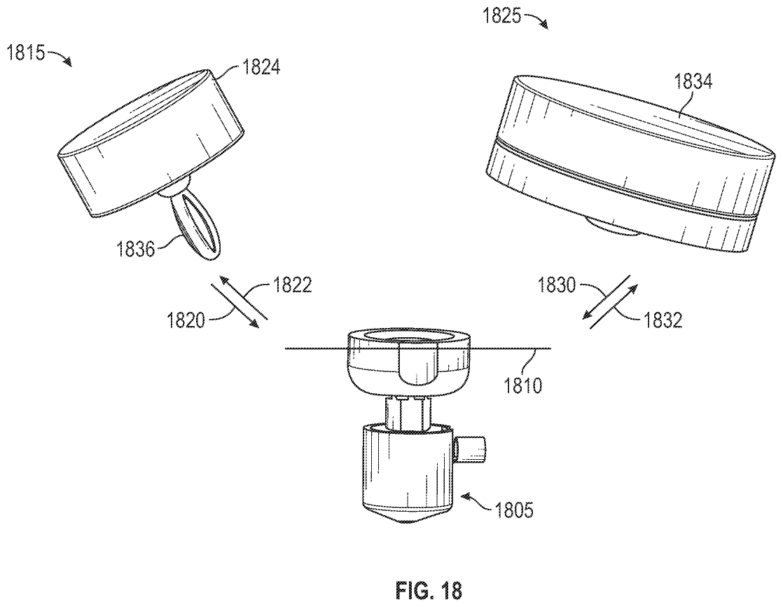

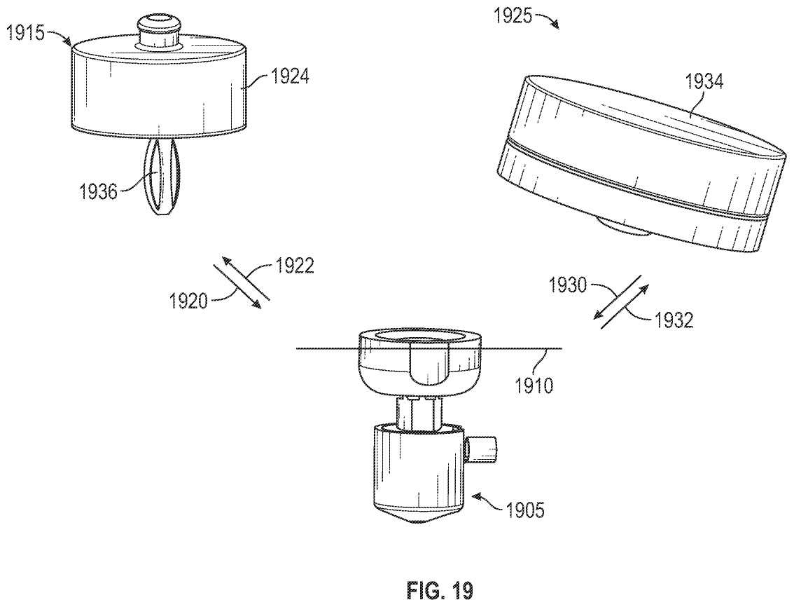

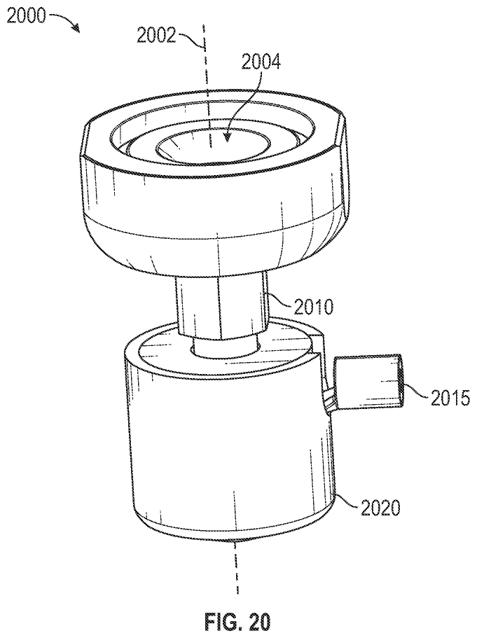

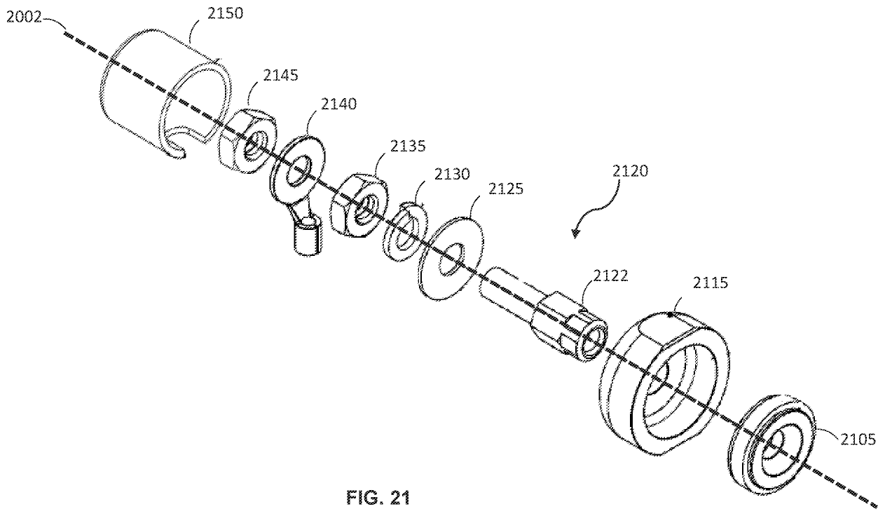

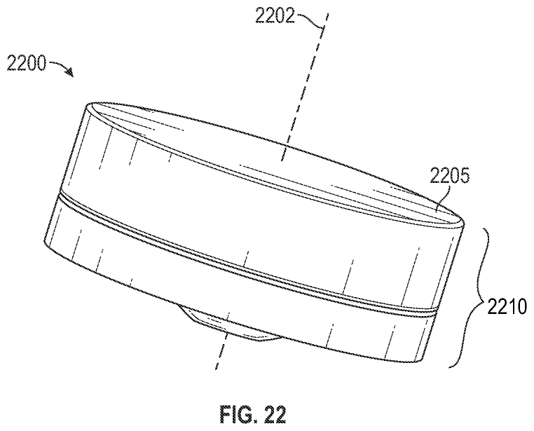

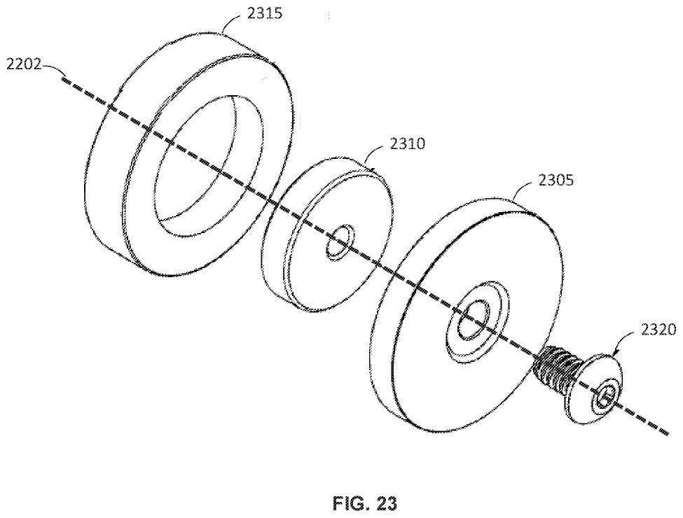

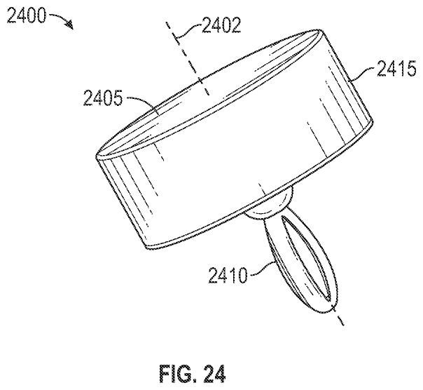

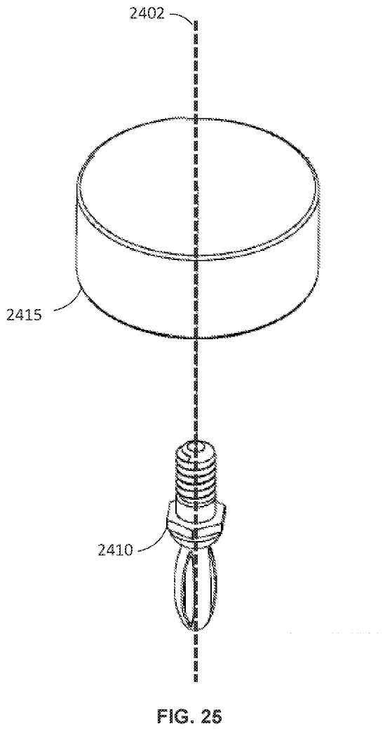

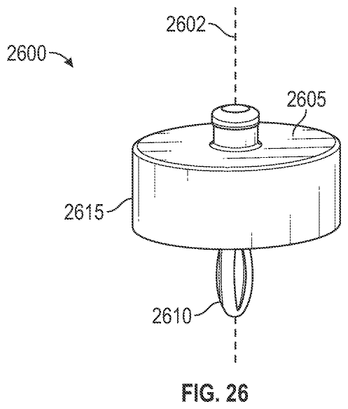

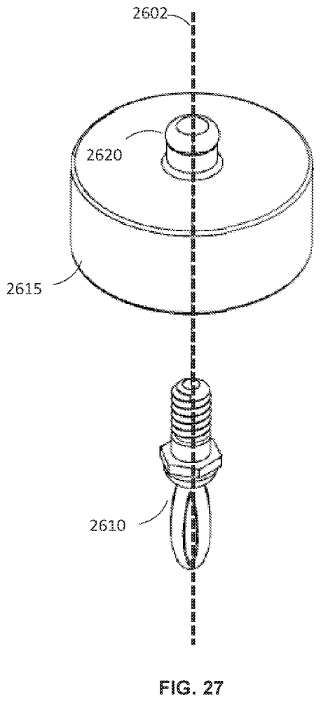

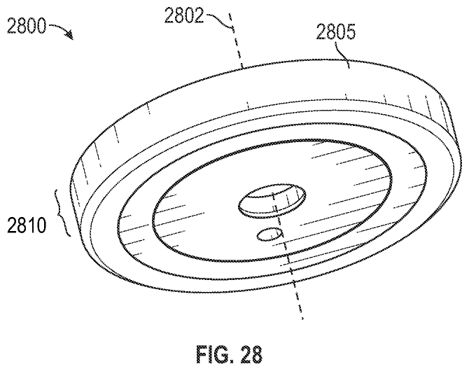

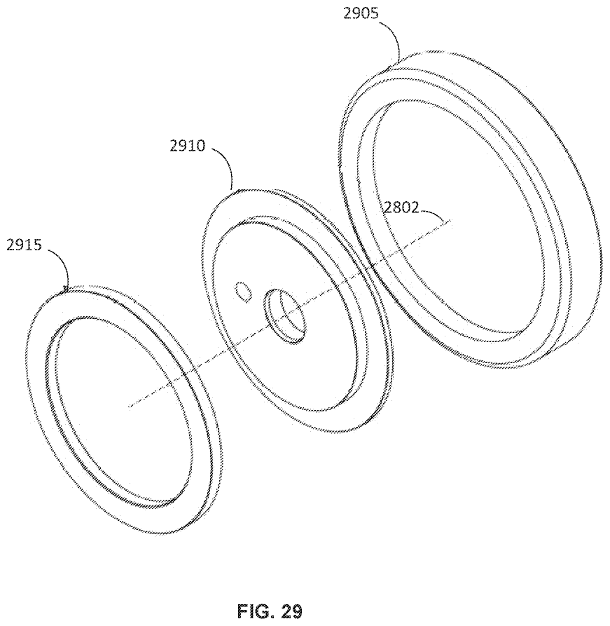

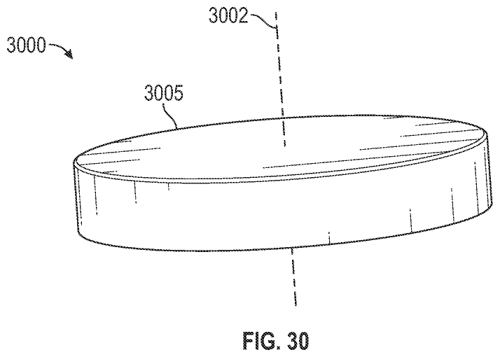

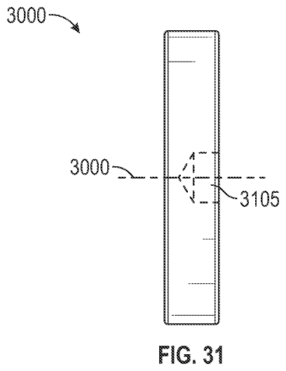

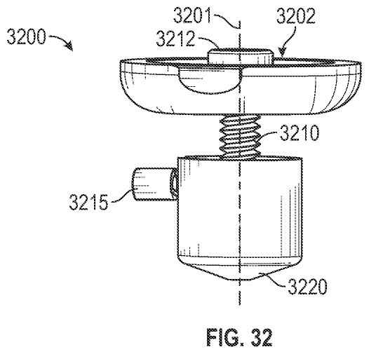

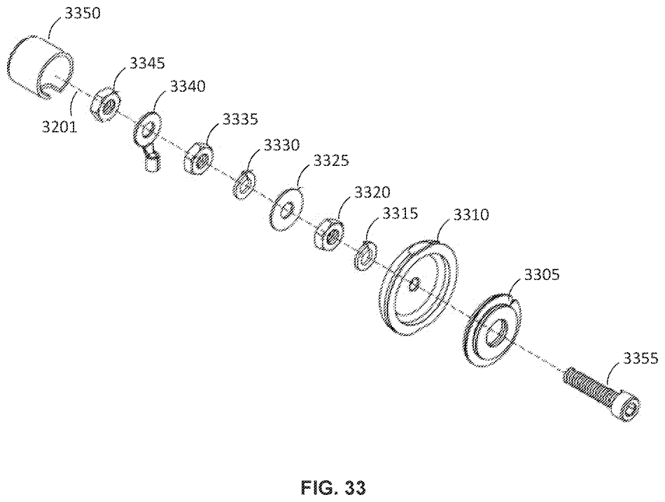

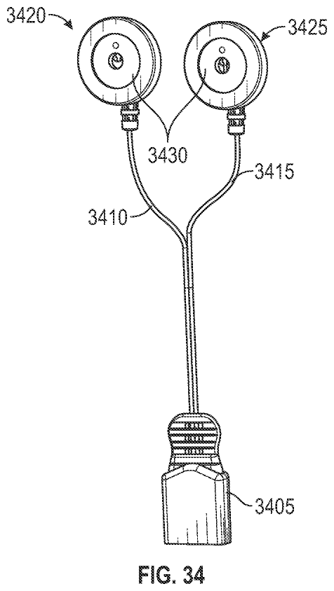

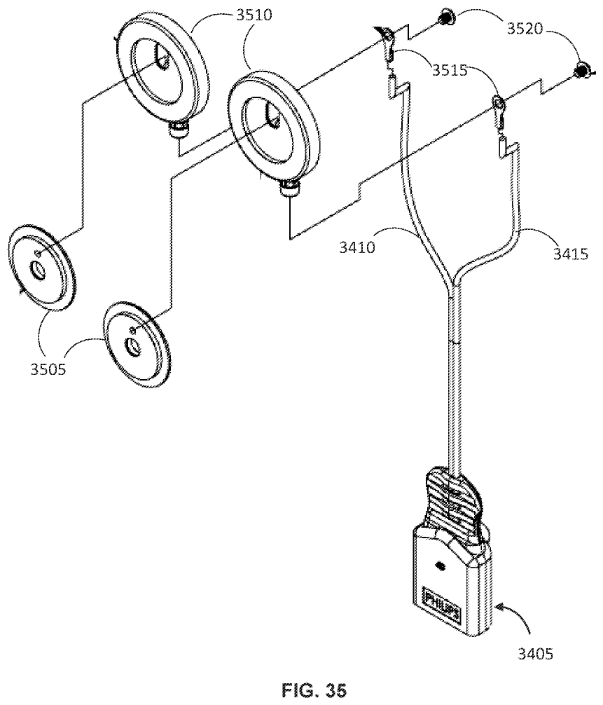

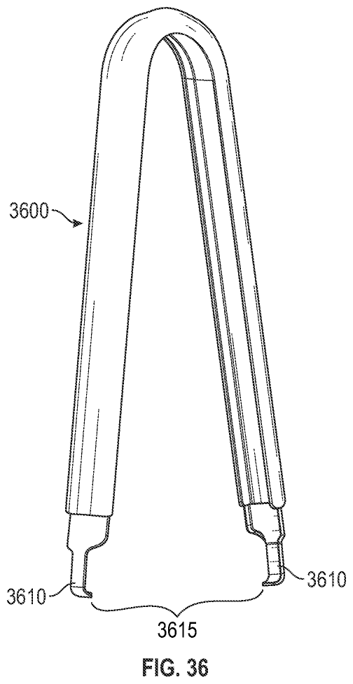

Referring to FIG. 18, shown therein is a partial cross-sectional side view of a portion of the patient simulator 100 of FIG. 1 showing use of interchangeable electrical interface components, according to one or more aspects of the present disclosure. Each of the plurality of electrical connectors of the electrical connector system 115 may include a base 1805. The base 1805 maybe fixedly attached to the simulated body portion 110. In some instances, the base 1805 maybe fixedly attached to and/or within a skin layer 1810 of the simulated body portion 110. In some instances, the base 1805 maybe configured to be in electrical communication with the EKG circuitry 135 and/or defibrillation circuitry 140. The base 1805 may include a magnetic component. The magnetic component may have any suitable shape, including annular, geometrical, non-geometrical, and/or combinations thereof. The magnetic component may include a single piece or multiple pieces. In some instances, the base 1805 maybe fixed to the simulated body portion using any suitable technique, including through the use of one or more fasteners, adhesives, welds, and/or other mechanisms for fixedly connecting the base 1805 to a portion of the simulated body portion of the patient simulator. In some aspects, an outer surface of the base 1805 maybe recessed relative to a skin surface of the patient simulator 100, generally aligned with the skin surface of the patient simulator 100, or raised above the skin surface of the patient simulator 100.

A first electrical interface component 1815 maybe removably coupled 1820 and/or uncoupled 1822 from the base 1805. When removably coupled 1820 to the base 1805, the coupling or attachment to the base 1805 maybe based at least in part on an interaction with a magnetic component in the base. By way of non-limiting example, the first electrical interface component 1815 maybe configured with a planar surface interface 1824 as depicted in FIG. 18.

A second interface component 1825 that may be removably coupled 1830 or uncoupled 1832 from the base 1805, and when coupled to the base 1805, the second interface component 1815 is removably coupled or attached. The coupling or attaching may be based at least in part on an interaction with a magnetic component in the base. By way of non-limiting example, the second interface component 1825 maybe configured with a blind interface 1834. The second interface component 1825 may prevent conductive coupling of external EKG equipment to the EKG circuitry 135. In some aspects, the second interface component 1825 may serve as a protective cover for the base 1805 or some of the components of the base 1805, as described herein. In some instances, a second interface component 1825 may match the skin tone of a patient simulator 100, resulting a blank connection point on the patient simulator. Thus, by way of the non-limiting example depicted in FIG. 18, the first electrical interface component 1815 and the second interface component 1825 maybe structurally different, based at least in part on their different connector configurations. If there is no electrical interface component or interface component coupled to the base 1805, then either the first electrical interface component 1815 maybe removably coupled 1820 or the second interface component 1825 maybe removably coupled 1832 to the base 1805.

In some instances, the first electrical interface component 1815 and/or the second interface component 1825 include a banana plug connector 1836, where the male component is integrated into the electrical interface component 1815, and the female component of the connector is integrated into the base 1805, as shown in FIG. 18. In some instances, the banana plug connector 1836 extends through and engages a central opening of base 1805. In some aspects, the central opening may be an opening in the magnetic component (e.g., an annular magnetic component) of the base 1805. In some instances, the first electrical interface component 1815 and/or the second interface component 1825 may include a banana plug connector where the male component is integrated into the base 1805 and the female component of the connector is integrated into the electrical interface component 1815 and interface component 1825. In some instances, the second interface component 1825 may not include a banana plug connector.

Referring to FIG. 19, shown therein is a partial cross-sectional side view of a portion of the patient simulator 100 of FIG. 1 showing use of interchangeable electrical interface components, according to one or more aspects of the present disclosure. Each of the plurality of electrical connectors of the electrical connector system 115 may include a base 1905. The base 1905 maybe fixedly attached to the simulated body portion 110. In some instances, the base 1905 maybe fixedly attached to and/or within a skin layer 1910 of the simulated body portion 110. In some instances, the base 1905 maybe configured to be in electrical communication with the EKG circuitry 135 and/or defibrillation circuitry 140. The base 1905 may include a magnetic component. The magnetic component may have any suitable shape, including annular, geometrical, non-geometrical, and/or combinations thereof. The magnetic component may include a single piece or multiple pieces. In some instances, the base 1905 maybe fixed to the simulated body portion using any suitable technique, including through the use of one or more fasteners, adhesives, welds, and/or other mechanisms for fixedly connecting the base 1905 to a portion of the simulated body portion of the patient simulator. In some aspects, an outer surface of the base 1905 maybe recessed relative to a skin surface of the patient simulator 100, generally aligned with the skin surface of the patient simulator 100, or raised above the skin surface of the patient simulator 100.

A first electrical interface component 1915 maybe removably coupled 1920 and/or uncoupled 1922 from the base 1905. When removably coupled 1920 to the base 1905, the coupling or attachment to the base 1905 maybe based at least in part on an interaction with a magnetic component in the base. By way of non-limiting example, the first electrical interface component 1915 maybe configured with a snap connection interface 1924 as depicted in FIG. 19.

A second interface component 1925 that may be removably coupled 1930 or uncoupled 1932 from the base 1905, and when coupled to the base 1905, the second electrical interface component 1915 is removably coupled or attached. The coupling or attaching may be based at least in part on an interaction with a magnetic component in the base. By way of non-limiting example, the second electrical interface component 1925 maybe configured with a blind interface 1934. The second interface component 1925 may prevent conductive coupling of external EKG equipment to the EKG circuitry 135. In some aspects, the second interface component 1925 may serve as a protective cover for the base 1905 or some of the components of base 1905, as described herein. In some instances, a second interface component 1925 may match the skin tone of a patient simulator, resulting a blank connection point on the patient simulator 100. Thus, by way of the non-limiting example depicted in FIG. 19, the first electrical interface component 1915 and the second interface component 1925 maybe structurally different, based at least in part on their different connector configurations. If there is no electrical interface component coupled to the base 1905, then either the first electrical interface component 1915 maybe removably coupled 1920 or the second interface component 1925 maybe removably coupled 1932 to the base 1905.

In some instances, the first electrical interface component 1915 and/or the second interface component 1925 include a banana plug connector 1936, where the male component is integrated into the electrical interface component 1915, and the female component of the connector is integrated into the base 1905, as shown in FIG. 19. In some instances, the banana plug connector 1936 extends through and engages a central opening of base 1905. In some aspects, the central opening may be an opening in the magnetic component (e.g., an annular magnetic component) of the base 1905. In some instances, the first electrical interface component 1915 and/or the second interface component 1925 may include a banana plug connector where the male component is integrated into the base 1905 and the female component of the connector is integrated into the electrical interface component 1915 and interface component 1925. In some instances, the second interface component 1925 may not include a banana plug connector.

Referring to FIG. 20, shown therein is a perspective view of an EKG base 2000, according to one or more aspects of the present disclosure. FIG. 20 includes a longitudinal axis 2002, aligned with the proximal-distal axis. The EKG base 2000 may include a central opening 2004 at the distal end, a conductive component 2010, a channel 2015 for receiving a connection to EKG circuitry 135, and a containing element 2020 at the proximal end of the EKG base. When configured the EKG base 2000 facilitates electrical communication between the EKG circuitry 135 and external EKG equipment.

In some instances, the central opening 2004, located at the distal end of the EKG base 2000, allows for portions of electrical interface components to extend through the central opening 2004. The central opening 2004 maybe configured to have a cross section in a plane transverse to the longitudinal axis of the base.

In some aspects, the conductive component 2010 facilitates electrical communication between a removably coupled electrical interface component and the EKG circuitry. The conductive component may also serve as a means for physical connection of the base 2000 with an electrical interface component. In some instances, the channel 2015 may receive or deliver a wire to the components of the base forming the electrical pathway. By way of non-limiting example, the wire may connect to the conductive component 2010.

In some instances, the containing element 2020 is cylindrical in shape with an end cap at one end of the cylinder, where the axis of the cylinder is parallel to the longitudinal axis of the base. The containing element 2020 may facilitate the physical connection to the patient simulator 100. In particular, the outer surface of the containing element may be in physical contact with the simulated body portion 110.

Referring to FIG. 21, shown therein is an exploded view of the EKG base of FIG. 20, according to one or more aspects of the present disclosure. FIG. 21 includes a longitudinal axis 2002, aligned with the proximal-distal axis. A magnet 2105 is disposed concentrically interior to a magnet holder 2115, where the center of the concentrically disposed components are defined by the longitudinal axis 802. A magnet holder 815 is disposed proximally relative to the magnet 805. An EKG jack connector 2120 is comprised by a laterally extended portion 2122 that may be, at least partially, located proximally relative to the magnet holder 2115. A first flat washer 2125 is proximally located relative to the laterally extended portion 822 of the EKG jack screw 2120. A split lock washer 2130 is located proximally to the first flat washer 2125. A first nut 2135 is located proximally to the split lock washer 2130. A terminal ring 2140 is located proximally to the first nut 2135. A second nut 2145 is located proximally to the terminal ring 2140. A cap 2150 is, at least partially, located proximally to the second nut 2145.

Referring to FIG. 22, shown therein is a perspective view of an interface component for EKG, according to one or more aspects of the present disclosure. FIG. 22 includes a longitudinal axis 2202, aligned with the proximal-distal axis. The first EKG interface component 2200 may include a planar surface 2205, and first EKG interface body 2210.

In some instances, the planar surface 2205 comprises a blind interface, as described above with respect to FIG. 18. The planar surface 2205 which may prevent EKG training equipment from electrically coupling to EKG circuitry 135.

In some instances, the first EKG interface body 2210 comprises a component that interacts with the magnet 805 in the EKG base 2000.

Referring to FIG. 23, shown therein is an exploded view of the electrical interface component for EKG depicts in FIG. 22. FIG. 23 includes a longitudinal axis 2202, aligned with the proximal-distal axis. The first EKG interface component 2200 comprises a magnet holder cap 2305, a blind plate 2310, a blind support 2315, and a screw 2320. The blind plate 2310 is located distally to the magnet holder cap 2305. The blind support 2315 is located distally to the blind plate 2310. A screw 2320 securely fastens the magnet holder cap 2305 and blind plate 2310, and, in some instances, the blind support 2315. When assembled the head of the screw 2320 rests on the proximal side of the magnet holder cap 2305.

Referring to FIG. 24, shown therein is a perspective view of an electrical interface component configured for EKG, according to one or more aspects of the present disclosure. FIG. 9 includes a longitudinal axis 2402, aligned with the proximal-distal axis. The first EKG electrical interface component 2400 may include a planar surface 2405, banana plug 2410, and first EKG interface body 2415.

In some instances, the planar surface 2405 is comprised of electrically conductive material. The planar surface 2405 maybe put into electrical contact with an EKG connector associated with EKG training equipment. In some instances, the planar surface 2405 comprises a portion of the electrical pathway between the EKG circuitry 135 and the EKG training equipment.

In some instances, the banana plug 2410 provides a mechanism for physical connection between the first EKG electrical interface component and the EKG base 2000. When engaged with the EKG base 2000, the banana plug 2410 causes the first EKG electrical interface component 2400 to be removably coupled to the EKG base 2000. In some instances, when the banana plug 2410 is engaged with the EKG base 2000, it provides an electrical connection and/or a physical connection. When coupling the first EKG interface component 2400 with the EKG base 2000, the banana plug 2410 extends through the central opening 2004 of the EKG base 2000.

In some instances, the first EKG interface body 2415 comprises a component that interacts with the magnet 2105 in the EKG base 2000.

Referring to FIG. 25, shown therein is an exploded view of the electrical interface component for EKG depicts in FIG. 24. In some instances, the banana plug 2410 may fasten to the interface body 2415 via threading on a distal portion of the banana plug and complementary threading on a surface of a cavity in the interface body 2415, the cavity being cylindrical and the longitudinal axis of such cylinder aligned with axis 2402.

Referring to FIG. 26, shown therein is a perspective view of an electrical interface component configured for EKG, according to one or more aspects of the present disclosure. FIG. 26 includes a longitudinal axis 2602, aligned with the proximal distal axis. A second EKG electrical interface component 1600 may include a snap connection interface 2605, banana plug 2610, and second EKG interface body 2615.

In some instances, the snap connection interface 2605 is comprised of electrically conductive material. The snap connection interface 2605 maybe put into electrical contact with an EKG connector associated with EKG equipment. In some instances, the snap connection interface comprises a portion of the electrical pathway between the EKG circuitry 135 and the

EKG equipment.

In some instances, the banana plug 2610 provides a mechanism for physical connection between the second EKG electrical interface component 2600 and the EKG base 2000. When engaged with the EKG base 2000 via the banana plug 2610, the second EKG electrical interface component 2600 is removably coupled to the EKG base 2000. In some instances, when the banana plug is engaged with the EKG base 2000, it provides an electrical connection in addition to a physical connection. When coupling the second EKG electrical interface component 2600 with the EKG base 2000, the banana plug 2610 extends through the central opening 2004 of the EKG base 2000.

In some instances, the second EKG interface body 2615 comprises a component that interacts with the magnetic component of the magnet 2105 in the EKG base 2000.

Referring to FIG. 27, shown therein is an exploded view of the electrical interface component of FIG. 26, according to one or more aspects of the present disclosure. FIG. 27 includes a longitudinal axis 2602, aligned with the proximal-distal axis. A magnetic snap 2620 is disposed on the distal surface of second EKG interface body 2615. In some instances, the banana plug 2610 may fasten to the interface body 2615 via threading on a distal portion of the banana plug and complementary threading on a surface of a cavity in the interface body 2615, the cavity being cylindrical and the longitudinal axis of such cylinder aligned with axis 2602.

Referring to FIG. 28, shown therein is a perspective view of an interface component for defibrillation, according to one or more aspects of the present disclosure. FIG. 28 includes a longitudinal axis 2802, aligned with the proximal-distal axis. The first defibrillation electrical interface component 2800 may include a planar surface 2805, and first defibrillation interface body 2810.

In some instances, the planar surface 2805 comprises a blind interface, as described above with respect to FIG. 18. The planar surface 2805 may prevent defib training equipment from electrically coupling to defib circuitry 140. In some instances, the planar surface 2805 comprises a portion of the electrical pathway between the defib circuitry 140 and the defib training equipment.

In some instances, the first defib interface body 2810 comprises a component that interacts with the magnet in the defib base, e.g., as described with respect to FIG. 33, below.

Referring to FIG. 29, shown therein is an exploded view of the electrical interface component of FIG. 28, according to one or more aspects of the present disclosure. FIG. 29 includes a longitudinal axis 2802, aligned with the proximal-distal axis. The first defibrillation interface component 2800 may include a blind support 2905, a magnet holder cap 2910, and a blind retaining ring 2915. The magnet holder cap 2910 is located proximally to the blind support 2905. The blind retaining ring 2915 is located proximally to the magnet holder cap 2910.

Referring to FIG. 30, shown therein is a perspective view of an electrical interface component, according to one or more aspects of the present disclosure. FIG. 30 includes a longitudinal axis 3002, aligned with the proximal-distal axis. The second defib electrical interface component 3000 may include a planar surface 3005.

In some instances, the planar surface 3005 is comprised of electrically conductive material. The planar surface 3005 maybe put into electrical contact with a defib connector associated with defib training equipment. In some instances, the planar surface 3005 comprises a portion of the electrical pathway between the defib circuitry 140 and the defib training equipment. In some instances, the planar surface 3005 may further comprise a snap connection similar to those described herein with respect to FIGS. 11-12 and 26-27.

In some instances, the second defib interface component 3000 comprises a component that interacts with a magnet in defib base, described with respect to FIG. 32.

Referring to FIG. 31, shown therein is a cross-sectional view of the electrical interface component of FIG. 30, according to one or more aspects of the present disclosure. FIG. 31 includes a longitudinal axis 3002, aligned with the proximal-distal axis. In some aspects, the electrical interface component 3000 includes a cavity 3105. Cavity 3105 may facilitate the electrical coupling of a defib connector and a defib base as described in FIG. 32.

Referring to FIG. 32, shown therein is a perspective of a defibrillation base, according to one or more aspects of the present disclosure. FIG. 32 includes a longitudinal axis 3201, defining a proximal-distal direction. The defibrillation base 3200 may include a central opening 3202 at the distal end of the defibrillation base 3200, a conductive component 3210, a channel 3215 for receiving a connection to defibrillation circuitry 140, a containing element 3220 at the proximal end of the defibrillation base 3200. In some instances, the defibrillation base 3200 comprises an electrical pathway whereby the defibrillation circuitry 140 and external defibrillation equipment are in electrical communication.

In some instances, the central opening 3202, located at the distal end of the defibrillation base 3200, allows for portions of electrical interface components to extend through the central opening 3202. The central opening 3202 maybe configured to have a cross section in a plane transverse to the longitudinal axis of the base. In some instances, a conductive component 3210 comprises a screw whose head 3212 may extend distally through the central opening 3202.

In some instances, the conductive component 3210 comprises an electrical pathway that allows electrical communication between a removably coupled electrical interface component, such as described in FIGS. 30-31, and the defibrillation circuitry 140. The conductive component 3210 may also serve as a means for physical connection between an electrical interface component, e.g., by receiving a banana plug in the head 3212 of the screw.

In some instances, the channel 3215 may receive or deliver a wire to the components of the base comprising the electrical pathway. By way of non-limiting example, the wire may be in direct or indirect electrical communication with the conductive component 3210.

In some instances, the containing element 3220 is cylindrical in shape with one end of the cylinder closed, where the axis of the cylinder is parallel to the longitudinal axis 3201 of the defibrillation base. The containing element 3220 maybe in physical contact with the simulated body portion 110. In particular, the outer surface of the containing element 3220 maybe in physical contact with the simulated body portion 110.

Referring to FIG. 33, shown therein is an exploded view of the defibrillation base of FIG. 32, according to one or more aspects of the present disclosure. FIG. 33 includes a longitudinal axis 3201, aligned with the proximal-distal axis. A magnet 3305 is disposed concentrically interior to a defibrillation magnet holder 3310, where the center of the concentrically disposed components are defined by the longitudinal axis 3201. A first split lock washer 3315 is disposed proximally relative to the defibrillation magnet holder 3310. A first nut 3320 is disposed proximally relative to the first split lock washer 3315. A flat washer 3325 is disposed proximally relative to the first nut 3320. A second split lock washer 3330 is disposed proximally relative to the flat washer 3325. A second nut 3335 is disposed proximally relative to the second split lock washer 3330. A terminal ring 3340 is disposed proximally relative to the second nut 3335. A third nut 3345 is disposed proximally relative to the terminal ring 3340. A cap 3350 is disposed proximally relative to the third nut 3345. In some instances, the cap has a cylindrical portion which surrounds some components, e.g., the various nuts and washers. A brass screw 3355 passes through every component of FIG. 33, thought it may not penetrate the cap 3350. In the order described, components with threading, such as the nuts, are complementarily fastened onto the screw via their respective threading.

Referring to FIG. 34, shown therein is a perspective view of defibrillator connectors, according to aspects of the present disclosure. FIG. 34 includes a connector housing 3405, connector cables 3410, 3415, and connector pads 3420, 3425. Connector housing 3405 maybe any number of connector housing available commercially. Connector pads 3420, and 3425 are configured to make physical and/or electrical contact with the electrical interface components as described in FIGS. 28-31. Electrical contact may be established by a conducting surface 3430. During operation of defib training equipment, current flows through the wires of the connector cables 3410 and/or 3415, to simulate defibrillation treatment on the patient simulator 100.

Referring to FIG. 35, shown therein is a partially exploded view of the defibrillator connectors of FIG. 34, according to aspects of the present disclosure. In particular, FIG. 35 is an exploded view of the connector pads 3420, 3425 depicted in FIG. 34. Each connector pad is comprised by a magnetic holder cap 3505, a harness cover 3510, a terminal ring 3515 and a screw 3520. Each magnetic holder cap 3505 is partially contained within the harness cover 3510. A screw 3520 affixes the terminal ring 3515 to the magnetic holder cap 3505. In some aspects, the terminal ring 3515 comprises part of the conductive pathway between defibrillator training equipment, and a defib base, such as 3200 in FIG. 32. The terminal ring is electrically coupled and/or physically coupled to the wires in the connector cables 3410 and 3415.

Referring to FIG. 36, shown therein is a perspective view of an electrical interface component removal tool, according to aspects of the present disclosure. Removal tool 3600 includes two pincers 3610. Pincers 3610 may include curved ends to allow them to interpose between an electrical interface component and a base that are held together by magnetic and/or physical force, as described herein. In this regard, the pincers 3610 of the removal tool 3600 maybe utilized to separate and/or remove the electrical interface component from the base. In the absence of any force exerted by a user or other external mechanism, the pincers 3610 maybe separated by a distance 3615 that is greater than a diameter of an electrical interface component, as described herein.

In operation, the removal tool 3600 maybe held by a user and placed near the point of connection between an electrical interface component and a base. Next, the user may squeeze the removal tool 3600 to cause the pincers 3610 to engage or grab the electrical interface component and/or interpose between the electrical interface component and base. The separation of the electrical interface component and base caused by the pincers 3610 maybe sufficient to weaken the magnetic and/or physical forces holding the electrical interface component and the base together to allow the user to remove the electrical interface component from the base by pulling the electrical interface component away from the base using the pincers of the removal tool 3600. Alternatively, pincers 3610 may engage or otherwise apply a contact force to a proximal, side, and/or distal surface(s) of an electrical interface component and allow a user to separate an electrical interface component from a base and/or simulator body using the removal tool 3600.

At least one embodiment of the disclosure can be described in view of the following clauses:

1. A patient simulator, comprising: a simulated body portion; and an electrical connector system comprising: a base fixedly secured to a portion of the simulated body portion, the base including a magnetic component; a first electrical interface component configured to be removably coupled to the base based, at least in part, on an interaction with the magnetic component; and a second electrical interface component configured to be removably coupled to the base based, at least in part, on an interaction with the magnetic component, wherein the second electrical interface component is structurally different than the first electrical interface component.

2. The patient simulator of clause 1, wherein the base is in electrical communication with EKG circuitry of the simulated body portion.

3. The patient simulator of clause 1, wherein the base is in electrical communication with defibrillation circuitry of the simulated body portion.

4. The patient simulator of clause 1, wherein the base is fixedly secured to a skin layer of the simulated body portion.

5. The patient simulator of clause 1, wherein magnetic component is annular.

6. The patient simulator of clause 1, wherein the first electrical interface component is configured to interface with at least one of an EKG connector or a defibrillator connector.

7. The patient simulator of clause 6, wherein the first electrical interface component and base provide an electrical pathway between the at least one of the EKG connector or the defibrillator connector and at least one of EKG circuitry or defibrillation circuitry of the simulated body portion.

8. The patient simulator of clause 7, wherein a non-conducting element separates the magnetic component from the electrical pathway between the at least one of the EKG connector or the defibrillator connector and the at least one of the EKG circuitry or the defibrillation circuitry of the simulated body portion.

9. The patient simulator of clause 6, wherein the first electrical interface component is further configured to be removably coupled to the base by a physical connection.

10. The patient simulator of clause 9, wherein the physical connection also provides an electrical connection.

11. The patient simulator of clause 9, wherein the magnetic component is annular.

12. The patient simulator of clause 11, wherein a portion of the first electrical interface component extends through a central opening of the magnetic component when the first electrical interface is removably coupled to the base.

13. The patient simulator of clause 1, wherein the second electrical interface component is configured to interface with at least one of an EKG patch or a defibrillator patch.

14. The patient simulator of clause 13, wherein the second electrical interface component includes a planar surface.

15. The patient simulator of clause 13, wherein the second electrical interface component and the base are configured to provide an electrical pathway between the at least one of the EKG patch or the defibrillator patch and at least one of EKG circuitry or defibrillator circuitry of the simulated body portion.

16. The patient simulator of clause 13, wherein the second electrical interface component is further configured to be removably coupled to the base by a physical connection.

17. The patient simulator of clause 16, wherein the physical connection also provides an electrical connection to the base.

18. The patient simulator of clause 16, wherein the magnetic component is annular.

19. The patient simulator of clause 18, wherein a portion of the second electrical interface component extends through a central opening of the magnetic component when the second electrical interface is removably coupled to the base.

20. The patient simulator of clause 1, further comprising: a plurality of the bases fixedly secured to the simulated body portion; a plurality of the first electrical interface components; and a plurality of the second electrical interface components.

21. The patient simulator of clause 20, wherein the plurality of the bases are fixedly secured to the simulated body portion in one or more positions associated with 1-lead, 3-lead, 4-lead, 6-lead, or 12-lead EKG monitoring or defibrillation.

22. The patient simulator of clause 1, wherein the simulated body portion includes a torso.

23. The patient simulator of clause 22, wherein the simulated body portion includes a full body manikin.

24. The patient simulator of clause 1, further comprising at least one of EKG circuitry or defibrillator circuitry.

25. An electrical connector system for a simulated body portion, the electrical connector system comprising: a base configured to be fixedly secured to a portion of the simulated body portion, the base including a magnetic component; a first electrical interface component configured to be removably coupled to the base based, at least in part, on an interaction with the magnetic component; and a second electrical interface component configured to be removably coupled to the base based, at least in part, on an interaction with the magnetic component, wherein the second electrical interface component is structurally different than the first electrical interface component.

26. The electrical connector system of clause 25, wherein the base is configured to be in electrical communication with EKG circuitry of the simulated body portion.

27. The electrical connector system of clause 25, wherein the base is configured to be in electrical communication with defibrillation circuitry of the simulated body portion.

28. The electrical connector system of clause 25, wherein the base is configured to be fixedly secured to a skin layer of the simulated body portion.

29. The electrical connector system of clause 25, wherein magnetic component is annular.

30. The electrical connector system of clause 25, wherein the first electrical interface component is configured to interface with at least one of an EKG connector or a defibrillator connector.

31. The electrical connector system of clause 30, wherein the first electrical interface component and base are configured to provide an electrical pathway between the at least one of the EKG connector or the defibrillator connector and at least one of EKG circuitry or defibrillation circuitry of the simulated body portion.

32. The electrical connector system of clause 31, wherein a non-conducting element separates the magnetic component from the electrical pathway between the at least one of the EKG connector or the defibrillator connector and the at least one of the EKG circuitry or the defibrillation circuitry of the simulated body portion.

33. The electrical connector system of clause 30, wherein the first electrical interface component is further configured to be removably coupled to the base by a physical connection.

34. The electrical connector system of clause 33, wherein the physical connection also provides an electrical connection.

35. The electrical connector system of clause 33, wherein the magnetic component is annular.

36. The electrical connector system of clause 35, wherein a portion of the first electrical interface component extends through a central opening of the magnetic component when the first electrical interface is removably coupled to the base.

37. The electrical connector system of clause 25, wherein the second electrical interface component is configured to interface with at least one of an EKG patch or a defibrillator patch.

38. The electrical connector system of clause 37, wherein the second electrical interface component includes a planar surface.

39. The electrical connector system of clause 37, wherein the second electrical interface component and the base are configured to provide an electrical pathway between the at least one of the EKG patch or the defibrillator patch and at least one of EKG circuitry or defibrillator circuitry of the simulated body portion.

40. The electrical connector system of clause 37, wherein the second electrical interface component is further configured to be removably coupled to the base by a physical connection.

41. The electrical connector system of clause 40, wherein the physical connection also provides an electrical connection to the base.

42. The electrical connector system of clause 40, wherein the magnetic component is annular.

43. The electrical connector system of clause 42, wherein a portion of the second electrical interface component extends through a central opening of the magnetic component when the second electrical interface is removably coupled to the base.

44. The electrical connector system of clause 25, further comprising: a plurality of the bases; a plurality of the first electrical interface components; and a plurality of the second electrical interface components.

45. The electrical connector system of clause 44, wherein the plurality of the bases are configured to be fixedly secured to the simulated body portion in one or more positions associated with 1-lead, 3-lead,4-lead, 6-lead, or 12-lead EKG monitoring or defibrillation.

46. A method, comprising: obtaining a patient simulator, the patient simulator including: a simulated body portion and an electrical connector system comprising: a base fixedly secured to a portion of the simulated body portion, the base including a magnetic component; and a first electrical interface component removably coupled to the base based, at least in part, on an interaction with the magnetic component; removing the first electrical interface component from the base; and coupling a second electrical interface component to the base based, at least in part, on an interaction with the magnetic component, wherein the second electrical interface component is structurally different than the first electrical interface component.

47. The method of clause 46, further comprising: performing an EKG simulation using the simulated body portion, the base, and at least one of the first electrical interface component or the second electrical interface component.

48. The method of clause 47, wherein the performing the EKG simulation includes coupling an EKG connector to the at least one of the first electrical interface component or the second electrical interface component.

49. The method of clause 46, further comprising: performing a defibrillation simulation using the simulated body portion, the base, and at least one of the first electrical interface component or the second electrical interface component.

50. The method of clause 49, wherein the performing the defibrillation simulation includes coupling a defibrillator connector to the at least one of the first electrical interface component or the second electrical interface component.

51. The method of clause 46, wherein the removing the first electrical interface component comprises separating a physical connection between the base and the first electrical interface component.

52. The method of clause 51, wherein the separating the physical connection also separates an electrical connection between the base and the first electrical interface component.

53. The method of clause 52, wherein the separating the physical connection includes removing a portion of the first electrical interface component through a central opening of the magnetic component of the base.

54. The method of clause 46, wherein: the removing the first electrical interface component from the base is part of removing a plurality of first electrical interface components from a plurality of bases; and the coupling the second electrical interface component to the base is part of coupling a plurality of second electrical interface components to the plurality of bases.

55. The method of clause 54, wherein the coupling the plurality of second electrical interface components comprises coupling the plurality of second electrical interface components to the simulated body portion in one or more positions associated with 1-lead, 3-lead, 4-lead, 6-lead, or 12-lead EKG monitoring or defibrillation.

56. The method of clause 46, wherein the simulated body portion includes a torso.

57. The method of clause 46, wherein the simulated body portion includes a full body manikin.

58. The method clause 46, wherein: the first electrical interface component is configured to interface with at least one of an EKG connector or a defibrillator connector; and the second electrical interface component is configured to interface with at least one of an EKG patch or a defibrillator patch.

59. The method clause 46, wherein: the first electrical interface component is configured to interface with at least one of an EKG patch or a defibrillator patch; and the second electrical interface component is configured to interface with at least one of an EKG connector or a defibrillator connector.

60. The electrical connector system of clause 25, further comprising: a removal tool configured to: separate the first electrical interface component from the base; and separate the second electrical interface component from the base.

61. The electrical connector system of clause 60, wherein the removal tool comprises: a pair of opposed pincers sized and shaped to engage the first electrical interface component and the second electrical interface component.

Although illustrative embodiments have been shown and described, a wide range of modification, change, and substitution is contemplated in the foregoing disclosure and in some instances, some features of the present disclosure may be employed without a corresponding use of the other features. It is understood that such variations may be made in the foregoing without departing from the scope of the embodiment. Accordingly, it is appropriate that the appended claims be construed broadly and in a manner consistent with the scope of the present disclosure.

What is claimed is:

1. An electrical connector system for a simulated body portion, the electrical connector system comprising:
a base configured to be fixedly secured to a portion of the simulated body portion, the base including a magnetic component;
a first electrical interface component configured to be removably coupled to the base based, at least in part, on an interaction with the magnetic component; and
a second electrical interface component configured to be removably coupled to the base based, at least in part, on an interaction with the magnetic component, wherein the second electrical interface component is structurally different than the first electrical interface component.

2. The electrical connector system of claim 1, wherein the base is configured to be in electrical communication with EKG circuitry of the simulated body portion.

3. The electrical connector system of claim 1, wherein the base is configured to be in electrical communication with defibrillation circuitry of the simulated body portion.

4. The electrical connector system of claim 1, wherein the base is configured to be fixedly secured to a skin layer of the simulated body portion.

5. The electrical connector system of claim 1, wherein magnetic component is annular.

6. The electrical connector system of claim 1, wherein the first electrical interface component is configured to interface with at least one of an EKG connector or a defibrillator connector.

7. The electrical connector system of claim 6, wherein the first electrical interface component and base are configured to provide an electrical pathway between the at least one of the EKG connector or the defibrillator connector and at least one of EKG circuitry or defibrillation circuitry of the simulated body portion.

8. The electrical connector system of claim 7, wherein a non-conducting element separates the magnetic component from the electrical pathway between the at least one of the EKG connector or the defibrillator connector and the at least one of the EKG circuitry or the defibrillation circuitry of the simulated body portion.

9. The electrical connector system of claim 6, wherein the first electrical interface component is further configured to be removably coupled to the base by a physical connection.

10. The electrical connector system of claim 9, wherein the physical connection also provides an electrical connection.

11. The electrical connector system of claim 9, wherein the magnetic component is annular.

12. The electrical connector system of claim 11, wherein a portion of the first electrical interface component extends through a central opening of the magnetic component when the first electrical interface is removably coupled to the base.

13. The electrical connector system of claim 1, wherein the second electrical interface component is configured to interface with at least one of an EKG patch or a defibrillator patch.

14. The electrical connector system of claim 13, wherein the second electrical interface component includes a planar surface.

15. The electrical connector system of claim 13, wherein the second electrical interface component and the base are configured to provide an electrical pathway between the at least one of the EKG patch or the defibrillator patch and at least one of EKG circuitry or defibrillator circuitry of the simulated body portion.

16. The electrical connector system of claim 13, wherein the second electrical interface component is further configured to be removably coupled to the base by a physical connection.

17. The electrical connector system of claim 16, wherein the physical connection also provides an electrical connection to the base.

18. The electrical connector system of claim 16, wherein the magnetic component is annular.

19. The electrical connector system of claim 18, wherein a portion of the second electrical interface component extends through a central opening of the magnetic component when the second electrical interface is removably coupled to the base.

20. The electrical connector system of claim 1, further comprising:
a plurality of the bases;
a plurality of the first electrical interface components; and
a plurality of the second electrical interface components.
